(19) United States
(12) Patent Application Publication
(10) Pub. No.: US 2025/0209158 A1
(43) Pub. Date: Jun. 26, 2025

(54) ENHANCED ACCESS THREAT DETECTION FOR COLLABORATIVE SOFTWARE APPLICATION FRAMEWORKS

(71) Applicant: ATLASSIAN PTY LTD., Sydney (AU)

(72) Inventors: Anthony Knopp, New York, NY (US); Benjamin Walther, Mountain View, CA (US); Ryan Crumley, Austin, TX (US)

(21) Appl. No.: 18/394,004

(22) Filed: Dec. 22, 2023

(51) Int. Cl. G06F 21/55; G06F 21/54; G06F 21/56

(52) U.S. Cl. CPC G06F 21/554; G06F 21/54; G06F 21/566

(57) ABSTRACT

Techniques for enhanced access threat detection and mitigation for a collaborative software application framework are discussed herein. Embodiments are configured to access event data associated with the collaborative software application framework and identify at least one threat event record object based on the event data that describes an access pattern associated with an entity. Embodiments are also configured to determine, via a threat detection model, that the access pattern associated with the threat event record objects satisfies at least one access threshold parameter. In response to determining that the access pattern satisfies the at least one access threshold parameter, embodiments may generate, via the threat detection model, access threat alerts and cause display of the access threat alerts via an interactive threat detection dashboard.

### TECHNICAL FIELD

Embodiments of the present disclosure are generally directed to enhanced threat detection for collaborative software application frameworks, and more specifically to mitigating various data access threats for said collaborative software application frameworks.

### BACKGROUND

Various types of a malware, automated bots, and malicious actors pose data security threats to collaborative software application frameworks. Applicant has identified many deficiencies and problems associated with existing methods, apparatuses, and systems for detecting and mitigating various types of threats posed to collaborative software application frameworks. Through applied effort, ingenuity, and innovation, these identified deficiencies and problems have been solved by developing solutions that are in accordance with the embodiments of the present invention, many examples of which are described in detail herein.

### BRIEF SUMMARY

Various embodiments of the present disclosure are directed to improved apparatuses, systems, methods, and computer readable media for providing an artificial intelligence enabled threat detection for collaborative software application frameworks. These characteristics as well as additional features, functions, and details of various embodiments are described below and embodied by the listing of claims set forth herein.

### BRIEF DESCRIPTION OF THE SEVERAL VIEWS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein. To easily identify the discussion of any particular element or act, the most significant digit or digits in a reference number refer to the figure number in which that element is first introduced.

FIG. 1 is a block diagram of an exemplary architecture configured for enhanced threat detection for one or more collaborative software applications in accordance with one or more embodiments of the present disclosure.

FIG. 2 is a block diagram of an exemplary threat detection computing device structured in accordance with one or more embodiments of the present disclosure.

FIG. 3 is a block diagram of an exemplary client computing device structured in accordance with one or more embodiments of the present disclosure.

FIG. 4 is a block diagram of an exemplary threat detection management platform structured in accordance with one or more embodiments of the present disclosure.

FIG. 5 illustrates an operational example of a user interface of an interactive threat detection dashboard in accordance with one or more embodiments of the present disclosure.

FIG. 6 illustrates an operational example of a user interface of an interactive threat detection dashboard configured to render additional detailed information related to a respective access threat alert in accordance with one or more embodiments of the present disclosure.

FIG. 7 illustrates an operational example of a user interface of an interactive threat detection dashboard configured to display data associated with one or more threat detection policies in accordance with one or more embodiments of the present disclosure.

FIG. 8 illustrates another operational example of a user interface of an interactive threat detection dashboard configured to display data associated with one or more threat detection policies in accordance with one or more embodiments of the present disclosure.

FIG. 9 illustrates an operational example of a user interface of an interactive threat detection dashboard configured to generate a threat detection policy in accordance with one or more embodiments of the present disclosure.

FIG. 10 illustrates a flowchart representing a method for performing enhanced threat detection for one or more collaborative software applications in accordance with one or more embodiments of the present disclosure.

### DETAILED DESCRIPTION

Various embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. The terms “illustrative,” “example,” and “exemplary” are used to be examples with no indication of quality level. Like numbers refer to like elements throughout.

### Overview

Various embodiments of the present invention address technical problems associated with monitoring a collaborative software application framework in order to detect data access threats associated with various types of content data comprised within the collaborative software application framework. The nature of collaborative software application frameworks opens them up to many types of risk including various types of access threats capable of incurring unauthorized access to various content data, sensitive data sharing, content abuse, integration mesh risk, and/or supply chain risk for a respective collaborative software application framework. For example, a collaborative work platform associated with a respective collaborative software application framework may enable multiple client computing devices associated with respective user profiles associated with a company, enterprise, and/or other organizational structure to work simultaneously on documents, projects, software applications, issue mitigation tickets, and/or the like. Providing such digital collaboration and interconnectivity may make the respective collaborative software application framework vulnerable to various access threats.

In certain scenarios, one or more access threats to a respective collaborative software application framework may be data “crawling” threats caused by one or more of malware, spyware, automated bots, viruses, and/or bad actors attempting to crawl (e.g., view and/or obtain) one or more portions of content data associated with the respective collaborative software application framework. In various contexts, the crawling of the one or more portions of content data by the malware, spyware, automated bots, viruses, and/or bad actors may include accessing (e.g., viewing), exporting, importing, modifying, searching, and/or copying the one or more portions of content data. In some cases, the access threats (e.g., crawling threats) may be imposed by inside actors (e.g., personnel associated with the respective collaborative software application framework). In other cases, the access threats may be imposed by outside actors impersonating (e.g., “spoofing”) various administrative account credentials in order to gain access to the content data associated with the respective collaborative software application framework. It is therefore desirable to increase the security and privacy of the content data associated with a collaborative software application framework by facilitating the detection and mitigation of various access threats.

To address the aforementioned technical problems, embodiments described herein employ a threat detection management platform comprising a threat detection model configured to adaptively detect and/or mitigate one or more access threats for one or more collaborative software application frameworks. For example, in various embodiments, the threat detection management platform, in conjunction with the threat detection model, is configured to generate one or more access threat alerts based on one or more threat event record objects associated with the one or more collaborative software application frameworks. In this regard, the threat detection model employs one or more threat detection policies configured to detect the one or more access threats impacting a respective collaborative software application framework based on the one or more threat event record objects. In various examples, the threat detection model is configured to determine which of the one or more threat detection policies to employ based on the one or more threat event record objects received from the threat detection stream service.

Embodiments of the present disclosure provide various technical improvements compared to existing alert monitoring systems by employing improved methods and architectures configured to adaptively detect and mitigate various access threats (e.g., crawling threats) associated with one or more collaborative software application frameworks. In contrast to various existing solutions, embodiments described herein are configured to enable customizable access threat detection modeling to meet the technical needs of various individuals, organizations, and/or enterprises. For example, an interactive threat detection dashboard associated with various embodiments described herein enables the generation and/or customization of one or more threat detection policies to be employed by the threat detection model associated with the threat detection management platform.

As such, embodiments described herein provide the technical benefit of automatically, efficiently, and simultaneously monitoring, detecting, and/or mitigating various access threats (e.g., crawling threats) for one or more collaborative software application frameworks, thereby reducing the computational load associated with the respective collaborative software application frameworks as well as for one or more associated client computing devices. Additionally, the embodiments described herein reduce the time, human resources, and mental load on one or more end users (e.g., alert responders) associated with one or more respective software application frameworks.

### Definitions

The term “collaborative software application framework,” refers to a software platform comprising one or more types of software applications (e.g., a collaborative work platform, a service-oriented platform, and/or a monolithic platform), which are described in more detail below. A collaborative software application framework may be a distributed framework wherein the one or more types of software applications (e.g., collaborative work platforms, service-oriented platforms, and/or monolithic platforms) may be configured to interface, integrate, transfer data, and/or otherwise communicate with one another via a respective communications network. A collaborative software application framework may be associated with a respective client (e.g., a respective individual, company, enterprise, and/or other organizational structure).

The term “collaborative work platform” refers to a software application that is directed towards enabling one or more client computing devices associated with one or more respective user profiles associated with a company, enterprise, and/or other organizational structure to work simultaneously on documents, projects, software applications, issue mitigation tickets, and/or the like. In some contexts, a client computing device associated with a collaborative work platform can generate one or more interactive user interfaces and/or dashboards associated with a particular collaborative document and/or collaborative workspace such that one or more client computing devices associated with one or more respective user profiles can simultaneously generate, update, and/or remove content data associated with the collaborative document and/or collaborative workspace. As such, the same representation of content data associated with a particular collaborative document and/or collaborative workspace is rendered on one or more respective interactive user interfaces associated with the one or more client computing devices, and any generation, update, and/or removal of the content data is rendered in near real time on the one or more respective interactive user interfaces.

A collaborative work platform can store a large number of collaborative documents and/or collaborative workspaces that may be accessible/editable by one or more user profiles. Each collaborative document and/or collaborative workspace may at each time be accessed by a group of user profiles that is larger than the group of user profiles that created the documents, and different portions of collaborative documents may be created by different user profiles. Moreover, various collaborative documents and/or collaborative workspaces created by different groups of user profiles may contain links/references to each other and may enable user profiles to transition from a first collaborative document and/or collaborative workspace to a second collaborative document and/or collaborative workspace by selecting the noted links/references. An example of a collaborative work platform that may use the access threat detection techniques disclosed herein is the Confluence® collaborative document management platform that is owned by Atlassian PTY LTD.

The term “service-oriented platform” refers to a software application designed to embody a modular programming architecture based on specific service types, wherein the modular programming may comprise existing services combined by user specification in order to create a custom software application. In some embodiments, the services within the modular programming may configure GUI for user interaction with each service in an individual manner without affecting other services within the service-oriented platform. A service-oriented platform is typically characterized by large networks of interdependent services and microservices that support a myriad of software features and applications. Indeed, some large service-oriented platforms may be comprised of topologies of 1,500 or more interdependent services and microservices. Such service-oriented platforms are nimble, highly configurable, and enable robust collaboration and communication between users at individual levels, team levels, and enterprise levels. Service-oriented platforms typically include large numbers of software applications. Each software application includes a number of features, with many features (e.g., user authentication features) shared between multiple software applications. Other features are supported only by one associated software application or a defined subset of software applications.

A given service-oriented platform could support hundreds of software applications and hundreds of thousands of features. Those applications and features could be supported by thousands of services and microservices that exist in vast and ever-changing interdependent layers. Adding to this complexity is the fact that at any given time, a great number of software development teams may be constantly, yet unexpectedly, releasing code updates that change various software services, launch new software services, change existing features of existing software applications, add new software applications, add new features to existing software applications, and/or the like. The distributed nature of such service-oriented platforms may open up an associated collaborative software application framework to various external data security threats for which the embodiments of the present disclosure are configured to address.

The terms “monolithic platform,” or “monolithic software platform,” refer to a software application designed to embody an architecture in which the front end and back end systems are combined into a single platform. Monolithic software platforms are self-contained in that they can perform each operation needed to complete their intended purpose or function.

The term “threat detection management platform” refers to a software service that is configured to monitor and mitigate one or more data access threats for one or more collaborative software application frameworks (e.g., associated with a collaborative work platform, a service-oriented platform, and/or a monolithic software platform) and may be deployed via a computer hardware, software, firmware, and/or a combination thereof. The threat detection management platform is configured to detect and/or mitigate one or more types of access threats associated with one or more collaborative software application frameworks. An example threat detection management platform is Beacon® by Atlassian®.

The threat detection management platform comprises, integrates with, and/or otherwise employs a threat detection data service, a threat detection job service, a threat detection stream service, a threat detection model, and/or a threat detection computing device to detect and/or mitigate one or more access threats for one or more collaborative software application frameworks. For example, the threat detection management platform, in conjunction with the threat detection model, is configured to generate one or more access threat alerts based on one or more threat event record objects associated with the one or more collaborative software application frameworks.

The threat detection management platform is also configured to generate one or more interactive graphs, tables, notifications, and/or the like associated with the one or more access threat alerts. In various contexts, the one or more interactive graphs, tables, alert notifications, and/or the like may be displayed via an interactive threat detection dashboard rendered by one or more client computing devices associated with the one or more collaborative software application frameworks. Furthermore, the threat detection management platform is configured to facilitate the routing and/or transmission of said alert notifications to one or more appropriate alert responder profiles (e.g., alert responder profiles associated with a respective alert response team) associated with the collaborative software application framework.

The term “threat detection data service” refers to computer hardware, software, firmware, and/or a combination thereof configured to receive, store, manage, update, remove, aggregate, collate, compile, transmit, and/or otherwise process one or more portions of data associated with a threat detection management platform. For example, the threat detection data service is configured to process one or more portions of event data received from one or more respective collaborative software application frameworks associated with the threat detection management platform. In various embodiments, the one or more portions of event data are received from the one or more respective collaborative software application frameworks via a communications network. Furthermore, the one or more portions of event data are configured to be stored in a data lake associated with the threat detection data service.

The threat detection data service is configured to generate one or more dynamic table objects, where the one or more dynamic table objects are configurable data tables comprising a variable number of columns and/or rows. For example, the threat detection data service is configured to generate one or more dynamic table objects based on metadata associated with the event data stored in the data lake. In various contexts, the one or more dynamic table objects are generated based on an access threat detection job being executed by a threat detection job service associated with the threat detection management platform. Additionally, the one or more dynamic table object are configured to be generated, configured, edited, parsed, organized, searched, grouped, and/or the like based on one or more database commands issued by a respective computing device and/or service associated with the threat detection management platform.

The threat detection data service is also configured to generate one or more threat event record objects based on event data associated with the one or more dynamic table objects. For example, the threat detection data service is configured to generate one or more threat event record objects based on one or more database commands executed by the threat detection job service, where the one or more threat event record objects are generated based on event data associated with one or more dynamic table objects, and where the one or more database commands are executed based on an access threat detection job being executed by a threat detection job service.

In various examples, the threat detection data service embodies and/or integrates with a data service gateway. The data service gateway, in some embodiments, is comprised of computer hardware, software, firmware, and/or a combination thereof configured to receive and/or transmit data from one or more services, computing devices, and/or components associated with the threat detection management platform. For example, the data service gateway is configured to receive and/or transmit one or more portion of event data associated with one or more respective collaborative software application frameworks. Additionally or alternatively, the data service gateway is configured to receive one or more database commands to be executed by the threat detection data service from the threat detection job service. Additionally or alternatively, the data service gateway is configured to transmit one or more threat event record objects generated by the threat detection data service to a threat detection stream service associated with the threat detection management platform.

The term “event data” refers to electronically managed data generated via one or more client computing devices associated with one or more respective collaborative software application frameworks. In various examples, the event data associated with a respective collaborative software application framework is generated based on one or more logged portions of user input data, user access data, and/or user interactions associated with a collaborative work platform, service-oriented platform, and/or monolithic platform related to the respective collaborative software application framework.

For example, event data can be associated with an access, or “view”, of a respective page and/or portion of content data (e.g., a collaborative document, a restricted document, a collaborative workspace, an issue tracking object, a webpage, a computer program code repository, administrative account data, a datastore, etc.) associated with a respective collaborative software application framework by a computing device. Additionally or alternatively, event data can be associated with an export of a respective page and/or portion of content data associated with a respective collaborative software application framework by a computing device. Additionally or alternatively, event data can be associated with an import of a respective page and/or portion of content data associated with a respective collaborative software application framework by a computing device. Additionally or alternatively, event data can be associated with a modification of a respective page and/or portion of content data associated with a respective collaborative software application framework by a computing device.

event data is associated with various portions of metadata related to any respective user input data, user access data, and/or user interactions associated with a collaborative work platform, service-oriented platform, and/or monolithic platform related to the respective collaborative software application framework. For example, the metadata related to the respective user input data, user access data, and/or user interactions is associated with user identification data (e.g., computing device IP and/or MAC addresses, computing device location data, user account information, etc.), platform data (e.g., data related to a respective collaborative work platform, service-oriented platform, and/or monolithic platform), content data (e.g., data related to any accessed pages), and/or timestamp data. In various examples, the metadata associated with one or more portions of event data can be used by the threat detection data service to generate one or more dynamic table objects. Additionally or alternatively, in various examples, the metadata associated with one or more portions of event data can be used by the threat detection data service to generate one or more threat event record objects.

The term “threat detection job service” refers to computer hardware, software, firmware, and/or a combination thereof configured to generate, schedule, queue, execute, initiate, and/or otherwise manage one or more access threat detection jobs associated with the threat detection management platform. In various embodiments, the threat detection job service is configured to generate, schedule, queue, execute, initiate, and/or otherwise manage the one or more access threat detection jobs based on a predefined periodicity of time. Furthermore, the threat detection job service is configured to work in conjunction with the threat detection data service in order to generate one or more threat event record objects based on the one or more access threat detection jobs. For example, the threat detection job service is configured to facilitate the processing of one or more portions of event data stored in a data lake associated with the threat detection data service in order to generate one or more threat event record objects based on the one or more access threat detection jobs. In some contexts, the threat detection job service is configured to facilitate the processing of the one or more portions of event data stored in the data lake associated with the threat detection data service via a communications network associated with the threat detection management platform.

The term “access threat detection job” refers to an electronically managed data object comprising one or more portions of executable computer program code comprising one or more commands, instructions, methods, and/or functions configured to facilitate the operations of the threat detection job service and/or the threat detection data service associated with the threat detection management platform. For example, the threat detection job service is configured to facilitate the processing of one or more portions of event data stored in a data lake associated with the threat detection data service in order to generate one or more threat event record objects based on the one or more access threat detection jobs. A particular access threat detection job may be associated with a specific data source and/or type of content data of associated with a respective collaborative work platform, service-oriented platform, and/or monolithic platform related to a respective collaborative software application framework. For example, a particular access threat detection job may be configured to facilitate the processing of event data to generate threat event record objects related to one or more collaborative documents associated with a collaborative work platform related to a collaborative software application framework.

The term “threat event record object” refers to refers to an electronically managed data object that is configured to comprise various data, information, text, and/or other media used to describe a potential threat associated with a collaborative software application framework. A threat event record object is generated based on an access threat detection job initiated by the threat detection job service associated with the threat detection management platform, where the threat detection job service is configured to facilitate the processing of one or more portions of event data stored in a data lake associated with the threat detection data service. In various examples, a threat event record object may describe a potential threat that may adversely impact the operation of a respective collaborative software application framework. In various contexts, a threat event record object may describe a potential threat that is currently impacting a respective collaborative software application framework (e.g., in real time or near-real time), or a potential threat that has occurred with related to a respective collaborative software application framework in the past. In some examples, a threat event record object threat event record object describes an access pattern associated with an entity, where the access pattern is associated with an access to one or more components associated with the collaborative software application framework by the entity.

The term “access pattern” refers to one or more portions of data that describes a potential threat impacting the operation of a respective collaborative software application framework. For example, an access pattern associated with a respective threat event record object may describe that Entity A is viewing (e.g., accessing) more than X pages (e.g., collaborative documents) per Y minutes. As another example, an access pattern associated with a respective threat event record object may describe that Entity A is viewing (e.g., accessing) more than X restricted pages (e.g., private documents) per Y minutes. As another example, an access pattern associated with a respective threat event record object may describe that Entity B is exporting more than X pages (e.g., collaborative documents) in Y minutes. As another example, an access pattern associated with a respective threat event record object may describe that Entity B is exporting more than X collaborative workspaces in Y minutes.

The term “threat detection stream service” refers to refers to computer hardware, software, firmware, and/or a combination thereof configured to facilitate the transfer of one or more portions of data between various components of the threat detection management platform. For example, in various contexts, the threat detection stream service is configured to aggregate, schedule, stage, queue, execute, initiate, and/or otherwise manage one or more portions of data for transferring to and/or from the threat detection data service, the threat detection job service, the threat detection model, and/or the threat detection computing device of the threat detection management platform. In various embodiments, the threat detection stream service integrates with a communication network associated with the threat detection management platform.

For example, the threat detection stream service may be configured to retrieve and/or receive one or more threat event record objects from the threat detection data service (e.g., via the data service gateway). In various contexts, the threat detection stream service may be configured to retrieve and/or receive the one or more threat event record objects from the threat detection data service based on a predetermined periodicity of time (e.g., as configured by the threat detection computing device). In some contexts, the threat detection stream service is configured to transmit the one or more threat event record objects to the threat detection model.

The term “threat detection model” refers to a machine learning (ML) model configured to detect and/or mitigate adverse impacts to a respective collaborative software application framework. In various examples, the threat detection model may be configured as an artificial intelligence (AI) model, rules-based model, artificial neural network (ANN), convolutional neural networks (CNN), recurrent neural networks (RNN), and/or any other type of specially trained model that is configured to detect and/or mitigate one or more access threats associated with a respective collaborative software application framework. In various contexts, the one or more access threats may be caused by one or more of malware, spyware, automated bots, and/or bad actors attempting to crawl one or more portions of content data associated with the respective collaborative software application framework. In various contexts, the crawling of the one or more portions of content data associated with the respective collaborative software application framework may include accessing (e.g., viewing), exporting, importing, modifying, searching, and/or copying the one or more portions of content data.

In various embodiments, the threat detection model employs one or more threat detection policies configured to detect one or more access threats impacting a respective collaborative software application framework. The threat detection model determines which of the one or more threat detection policies to employ based on one or more threat event record objects received from the threat detection stream service. In various contexts, the threat detection model is configured to determine (e.g., by way of a respective threat detection policy) whether an access pattern associated a threat event record object satisfies one access threshold parameter of a plurality of access threshold parameters. In response to determining that the access pattern associated with the threat event record object satisfies the at least one access threshold parameter, the threat detection model is configured to generate an access threat alert associated with the collaborative software application framework. Additionally, the threat detection model is configured to assign a severity level to a respective access threat alert based on the threat detection policy used to generate the access threat alert and/or or the access pattern associated with the threat event record object that triggered the generation of the access threat alert. Furthermore, in various contexts, the threat detection model configured to cause display of the access threat alert via an interactive threat detection dashboard rendered on a client computing device associated with the collaborative software application framework.

The term “threat detection policy” refers to computer hardware, software, firmware, and/or a combination thereof configured to determine whether one or more threat event record objects are critical enough to warrant the generation of a respective access threat alert. In some examples, a threat detection policy is comprised of one or more portions of executable computer program code that is configured to process one or more threat event record objects to identify a potential source of risk associated with a respective collaborative software application framework and whether to generate one or more corresponding access threat alerts. In various embodiments, threat detection policy associated with a threat detection model is configured to receive one or more threat event record objects as model input and generate one or more access threat alerts as model output.

In various contexts, a respective threat detection policy may be employed to determine whether an access pattern associated a threat event record object satisfies at least one access threshold parameter of a plurality of access threshold parameters. In response to determining that the access pattern associated with the threat event record object satisfies the at least one access threshold parameter, the threat detection policy may direct that threat detection model to generate an access threat alert associated with the collaborative software application framework.

Furthermore, in various embodiments, the threat detection model employs one or more threat detection policies to make various decisions and/or cause execution of various actions. For example, in some contexts, the threat detection model employs the one or more threat detection policies to decide whether to generate an access threat alert for each respective threat event record object of the one or more threat event record objects received from the threat detection stream service. As another example, in some contexts, the threat detection model employs the one or more threat detection policies to decide whether to generate a single access threat alert based on a combination of the one or more threat event record objects received from the threat detection stream service.

In some embodiments, a threat detection policy employed by the threat detection model is generated based at least in part on at least one portion of client input data received via the interactive threat detection dashboard. For example, an end user associated with a respective client computing device can generate one or more threat detection policies by inputting client input data via the interactive threat detection dashboard. In various contexts, client input data associated with the threat detection policy being generated may include description data, severity data, category data, cadence data, schedule interval data, and/or trigger data.

The term “access threshold parameter” refers to an electronically managed data object comprising data that describes one or more values, ranges, limits, and/or the like associated with one or more potential access types associated with a respective collaborative software application framework (e.g., viewing, exporting, importing, modifying, searching, and/or copying of one or more portions of content data). In various examples, an access threshold parameter is associated with at least one of a view count, a view duration, a modification count, modification amount, export count, export amount, import count, and/or import amount associated with at least one portion of content data associated with a respective collaborative software application framework. Additionally, an access threshold parameter may be associated with a predetermined time interval used to determine whether an access pattern associated with a respective threat event record object satisfies (e.g., exceeds) the access threshold parameter.

The term “access threat alert” refers to an electronically managed data object that is configured to comprise various data, information, text, and/or other media used to describe a respective access threat and/or incident associated with a collaborative software application framework. As such, access threat alerts are configured to describe whether a collaborative software application framework (e.g., a collaborative work platform, service-oriented platform, and/or monolithic platform associated with the collaborative software application framework) is currently being accessed and/or has been accessed in the past in a suspicious manner. For example, in various contexts, an access threat alert may indicate that one or more portions of content data associated with a collaborative software application framework (e.g., a collaborative work platform, service-oriented platform, and/or monolithic platform associated with the collaborative software application framework) is currently being crawled and/or has potentially been crawled in the past (e.g., by an automated bot, malware, spyware, virus, bad actor, and/or the like). A respective access threat alert may also describe an impact to the operating functionality of the collaborative software application framework. Such operating functionality may include indicators regarding the performance of the collaborative software application framework (e.g., whether the various components of the collaborative software application framework are running at peak speed or slower than peak speed, if certain functions or capabilities are not running at peak performance or are not running at all, etc.).

In various embodiments, access threat alerts are associated with one or more alert attributes including at least one of an alert severity, an alert identifier, an access threat alert type, an alert description, an alert data source, an alert timestamp, an alert responder profile, an alert mitigation status, or an alert mitigation ticket. Access threat alerts and/or one or more portions of data related to access threat alerts may be generated and/or received by the threat detection management platform (e.g., via the threat detection model) and stored in a data lake associated with the threat detection data service. In various contexts, access threat alerts may be used by the threat detection management platform to generate and/or cause the transmission of one or more notifications (e.g., via an interactive threat detection dashboard).

Furthermore, one or more portions of data associated with the access threat alerts may be used to generate one or more interactive interface elements associated with the interactive threat detection dashboard including one or more interactive graphs, tables, diagrams, images, links, and/or the like that can be used to diagnose and/or analyze the performance of one or more collaborative software application frameworks. Additionally, in various examples, an access threat alert is associated with a threat detection payload, where the threat detection payload is associated with at least one portion of content data of the collaborative software application framework. In various contexts, the at least one portion of content data corresponds to an access threat alert type associated with the one access threat alert.

The term “access threat alert type” refers to one or more items of data by which an access threat alert type may be identified within a threat detection management platform. Access threat alert types include a collaborative document alert type, an issue tracking alert type, a suspicious search alert type, an administrative account alert type, or a code repository alert type.

The collaborative document alert type is associated with at least one of an unusual page activity alert associated with a respective collaborative document, a mass page export alert associated with one or more respective collaborative documents, a restricted document access alert, an unauthorized user access alert, or an alert associated with a high volume of collaborative document content being made public. Unusual activity associated with a respective collaborative document may correspond to an unusual amount of document views by a particular entity within a predefined amount of time. A mass page export alert may be generated when a particular entity is determined to be exporting a number of collaborative documents above an acceptable access threshold (e.g., an export of ten or more pages within a predefined time period). A restricted document access alert may be generated when a highly restricted page or document (e.g., a particular collaborative document) has been accessed and/or viewed an unacceptable number of times within a predefined time period. An unauthorized user access alert may be generated when an end user associated with a user profile lacking required credentials attempts to access a certain number of collaborative documents. Additionally, an access alert may be generated when an end user attempts to make one or more private collaborative documents public such that the collaborative documents may be accessed via a public network and/or by end user lacking the required credentials.

The issue tracking alert type is associated with at least one of a mass issue tracking object export alert or unusual issue activity associated with one or more issue tracking objects. A mass issue tracking object export alert may be generated when a particular entity is determined to be exporting a number of issue tracking objects above an acceptable access threshold (e.g., an export of ten or more issue tracking data objects within a predefined time period). Unusual activity associated with a respective issue tracking object may correspond to an unusual amount of issue tracking object views by a particular entity within a predefined amount of time.

The administrative account alert type is associated with at least one of an administrative account change alert, an external access granted alert, a security assertion markup language (SAML) alert, an administrative account application programming interface (API) token change alert, or alert associated with a connection of an administrative account to an external third-party service. An external access granted alert may be generated when an end user attempts to grant external access to one or more respective administrative accounts. An SAML alert may be generated when one or more web security credentials associated with an administrative account is updated. An API token change alert may be generated if one or more token identifiers associated with a respective API is updated by an end user. An access alert may also be generated if it is determined that an end user has attempted to grant access to an administrative account to a third-party service (e.g., an external email service, social media service, and/or the like).

The code repository alert type is associated with at least one of a mass code repository clone alert, a mass code repository export alert, or a mass code repository commit (e.g., import) alert. A mass code repository clone alert may be generated when it is determined that an end user has attempted to clone one or more code repositories associated with a respective collaborative software application framework. A mass code repository export alert may be generated when it is determined that an end user has attempted to export one or more code repositories associated with a respective collaborative software application framework. A mass code repository commit alert may be generated when it is determined that an end user has attempted to commit a predetermine amount of computer program code to one or more code repositories associated with a respective collaborative software application framework.

The term “alert identifier” refers to one or more items of data by which an access threat alert may be identified within a collaborative software application framework monitoring system. For example, an alert identifier may comprise text string(s), numerical character(s), alphabetical character(s), alphanumeric code(s), ASCII character(s), a pointer, an IP address, a MAC address, a memory address, other unique identifier, or a combination thereof.

The term “alert data source” refers to one or more items of data by which a service (e.g., feature, application, product, etc.) associated with a collaborative software application framework may be identified. In some embodiments, the alert data source may comprise data indicating the upstream and downstream services for each specific service associated with the collaborative software application framework. In some embodiments, the alert data source may comprise service tier level data to indicate the importance of the service (e.g., the importance of the service to an enterprise and/or end user using the collaborative software application framework) for the user of the collaborative software application framework (e.g., the collaborative work platform, the service-oriented platform, and/or the monolithic platform). In some embodiments, the alert data source may comprise data associated with other alert data sources which may indicate the number of impacted services from an access threat alert of a specific service. In some embodiments, a particular alert data source (e.g., and therefore a particular service) may be associated with specific alert responder profile within a collaborative software application framework.

The term “alert responder profile” refers to one or more entities associated with one or more respective personnel and/or responsible parties related to a collaborative software application framework that are intended to receive, review, acknowledge, mitigate, and/or otherwise manage access threat alerts associated with the collaborative software application framework. In various embodiments, an alert responder profile is associated with one or more entities associated with one or more alert response teams, alert response services (e.g. third-party alert response services), and/or any other entity capable of receiving, reviewing, acknowledging, mitigating, and/or otherwise managing access threat alerts.

In various embodiments, a respective alert response team related to a respective collaborative software application framework may be associated with one or more alert responder profiles, developer profiles, management profiles, administrative profiles, IT assistance profiles, help desk profiles, and/or the like. In such embodiments, the one or more profiles associated with the alert response team may be associated with a respective hierarchy, a specific level of access permissions, and/or a respective priority level. In various examples, the one or more profiles associated with the alert response team may be associated with one or more respective client computing devices. In one or more embodiments, one or more alert responder profiles may be embodied by, integrated with, and/or otherwise associated with one or more respective third-party alert response services (e.g., cloud-based alert mitigation services, cloud-based alert data storage platforms, and/or the like) associated with the collaborative software application framework. The threat detection management platform may be configured to determine one or more alert response profiles that have access permissions to view and/or receive data associated with one or more respective access threat alerts and/or one or more notifications associated with the one or more respective access threat alerts.

The term “collaborative document” refers to a data construct that comprises textual content of a digital file that can be generated based on various types of file formats, where the textual content of the file is configured to be editable/accessible by one or more client computing devices associated with one or more respective user profiles. For example, the textual content can include, but is not limited to, text, lists, tables, spreadsheets, flowcharts, and/or the like. A client computing device associated with a document collaboration platform can generate one or more interactive user interfaces associated with a particular collaborative document such that one or more client computing devices associated with one or more respective user profiles can simultaneously generate, update, and/or remove sequenced textual content associated with the collaborative document. One or more collaborative documents can be stored in a document collaboration data repository of a document collaboration platform that comprises the client computing device. For example, the document collaboration platform may enable a first user profile to share a collaborative document with one or more other user profiles, where each of the one or more user profiles may be given defined read/write access privileges to the collaborative document. An example of a collaborative document is a Confluence® page.

The term “issue tracking object” refers to a structured, electronically managed data object generated by an issue management system (e.g., associated with a collaborative software application framework) in response to a user interaction with an interactive issue creation interface accessible via a client computing device. An alert issue tracking object is associated with a respective issue and is organized in a manner that makes it processable, storable, and/or otherwise interpretable by the one or more components of an issue management system. An alert issue tracking object comprises respective metadata associated with the respective issue.

The term “issue” refers to a technical task associated with an issue management system including, but not limited to, a process step, a software development task, an alert, a conflict, error, or problem in at least one of the development, delivery, execution, debugging, incident identification, troubleshooting, and/or operation of a piece of software.

The term “client computing device” refers to a combination of computer hardware and/or software that is configured to access a service made available by a collaborative software application framework. Client computing devices may include, without limitation, smart phones, tablet computers, laptop computers, wearables, personal computers, enterprise computers, and the like.

The term “threat detection computing device” refers to a combination of computer hardware and/or software that is configured to provide a service to a client device. In various examples, a threat detection computing device may embody, be embodied by, interface with, integrate with, and/or otherwise be associated with a threat detection management platform. In some examples, a threat detection computing device is configured to communicate with one or more client computing devices using one or more computer networks.

The term “service” refers to a computer hardware, software, firmware, and/or a combination thereof associated with a respective computing device (e.g., a threat detection computing device) that is configured to execute one or more portions of executable computer program code configured to implement, facilitate, and/or manage the one or more techniques, methods, and/or processes described herein.

As used herein, the terms “data,” “content,” “content data,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

### Example Systems and Apparatuses of the Disclosure

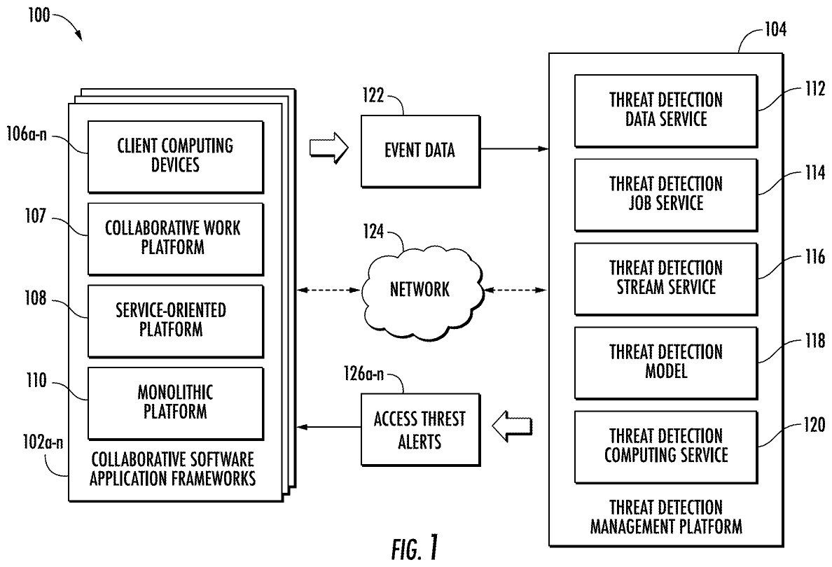

FIG. 1 is a block diagram of an exemplary architecture 100 configured for enhanced threat detection for one or more collaborative software applications in accordance with one or more embodiments of the present disclosure. The architecture 100 comprises collaborative software application frameworks 102a-n, a threat detection management platform 104, and network 124. As depicted, a respective collaborative software application framework 102a may comprise client computing devices 106a-n, a collaborative work platform 107, a service-oriented platform 108, and/or a monolithic platform 110. The threat detection management platform 104 may comprise a threat detection data service 112, a threat detection job service 114, a threat detection stream service 116, a threat detection model 118, and/or a threat detection computing device 120. Each of the components comprised in the architecture 100 are configured to work in tandem to facilitate the enhance detection and/or mitigation of one or more data access threats associated with one or more collaborative software application frameworks 102a-n. In various examples, each of the one or more collaborative software application frameworks may be associated with a discrete, distinct client (e.g., individual, company, enterprise, and/or other organizational structure).

The various components of the collaborative software application frameworks 102a-n (e.g., the client computing devices 106a-n) and the threat detection management platform 104 (e.g., the threat detection computing device 120) may communicate over the network 124. The network 124 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.).

For example, the network 124 may include a cellular telephone, a wireless network 802.11, 802.16, 802.20, and/or WiMAX network. Further, the network 124 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the page management system. In some embodiments, the protocol is a custom protocol of JavaScript Object Notation (JSON) objects sent via a WebSocket channel. In some embodiments, the protocol is JSON over RPC, JSON over REST/HTTP, and the like.

As shown in FIG. 1, a threat detection management platform 104 may be configured to receive and/or retrieve event data 122 from one or more collaborative software application frameworks 102a-n associated with various respective clients (e.g., respective individuals, companies, enterprises, and/or other organizational structures). For example, the threat detection management platform 104 may be configured to monitor the one or more collaborative software application frameworks 102a-n to receive and/or retrieve the one or more portions of event data 122 associated with said various respective clients. In various examples, the event data 122 associated with a respective collaborative software application framework 102a is generated based on one or more logged portions of user input data, user access data, and/or user interactions associated with a collaborative work platform 107, service-oriented platform 108, and/or monolithic platform 110 related to the respective collaborative software application framework 102a.

For example, event data 122 can be associated with an access, or “view”, of a respective page and/or portion of content data (e.g., a collaborative document, a restricted document, a collaborative workspace, an issue tracking object, a webpage, a computer program code repository, administrative account data, a datastore, etc.) associated with a respective collaborative software application framework 102a by a computing device. Additionally or alternatively, event data 122 can be associated with an export of a respective page and/or portion of content data associated with a respective collaborative software application framework 102a by a computing device. Additionally or alternatively, event data 122 can be associated with an import of a respective page and/or portion of content data associated with a respective collaborative software application framework 102a by a computing device. Additionally or alternatively, event data 122 can be associated with a modification of a respective page and/or portion of content data associated with a respective collaborative software application framework 102a by a computing device.

event data 122 is associated with various portions of metadata related to any respective user input data, user access data, and/or user interactions associated with a collaborative work platform 107, service-oriented platform 108, and/or monolithic platform 110 related to the respective collaborative software application framework 102a. For example, the metadata related to the respective user input data, user access data, and/or user interactions is associated with user identification data (e.g., computing device IP and/or MAC addresses, computing device location data, user account information, etc.), platform data (e.g., data related to a respective collaborative work platform 107, service-oriented platform 108, and/or monolithic platform 110), content data (e.g., data related to any accessed pages), and/or timestamp data. In various examples, the metadata associated with one or more portions of event data 122 can be used by the threat detection data service 112 to generate one or more dynamic table objects. Additionally or alternatively, in various examples, the metadata associated with one or more portions of event data 122 can be used by the threat detection data service 112 to generate one or more threat event record objects.

In various examples, the event data 122 may be generated by an application programming interface (API) associated with the threat detection management platform 104. For example, the one or more collaborative software application frameworks 102a-n associated with the threat detection management platform 104 may embody, integrate with, interface with, and/or otherwise employ an API associated with the threat detection management platform 104. In such examples, the API may be configured to automatically generate event data 122 upon the detection of user input data, user access data, and/or user interactions associated with a respective collaborative software application framework of the collaborative software application frameworks 102a-n. As such, the threat detection management platform 104 may, in various examples, automatically receive one or more portions of event data 122 generated by the API associated with the threat detection management platform 104.

The threat detection management platform 104 comprises, integrates with, and/or otherwise employs a threat detection data service 112, a threat detection job service 114, a threat detection stream service 116, a threat detection model 118, and/or a threat detection computing device 120 to detect and/or mitigate one or more access threats for one or more collaborative software application frameworks 102a-n. For example, the threat detection management platform 104, in conjunction with the threat detection model 118, is configured to generate one or more access threat alerts 126a-n based on one or more threat event record objects associated with the one or more collaborative software application frameworks 102a-n.

The threat detection management platform 104 is also configured to generate one or more interactive graphs, tables, notifications, and/or the like associated with the one or more access threat alerts 126a-n. In various contexts, the one or more interactive graphs, tables, alert notifications, and/or the like may be displayed via an interactive threat detection dashboard rendered by one or more client computing devices 106a-n associated with the one or more collaborative software application frameworks 102a-n. Furthermore, the threat detection management platform 104 is configured to facilitate the routing and/or transmission of said alert notifications to one or more appropriate alert responder profiles (e.g., alert responder profiles associated with a respective alert response team) associated with the collaborative software application framework 102a.

The threat detection data service 112 associated with the threat detection management platform 104 may be configured to receive, store, manage, update, remove, aggregate, collate, compile, transmit, and/or otherwise process one or more portions of data associated with a threat detection management platform 104. For example, the threat detection data service 112 is configured to process one or more portions of event data 122 received from one or more respective collaborative software application frameworks 102a-n associated with the threat detection management platform 104. In various embodiments, the one or more portions of event data 122 are received from the one or more respective collaborative software application frameworks 102a-n via a communications network (e.g., network 124). Furthermore, the one or more portions of event data 122 are configured to be stored in a data lake associated with the threat detection data service 112.

The threat detection job service 114 associated with the threat detection management platform 104 may be configured to generate, schedule, queue, execute, initiate, and/or otherwise manage one or more access threat detection jobs associated with the threat detection management platform 104. In various embodiments, the threat detection job service 114 is configured to generate, schedule, queue, execute, initiate, and/or otherwise manage the one or more access threat detection jobs based on a predefined periodicity of time. Furthermore, the threat detection job service 114 is configured to work in conjunction with the threat detection data service 112 in order to generate one or more threat event record objects based on the one or more access threat detection jobs. For example, the threat detection job service 114 is configured to facilitate the processing of one or more portions of event data 122 stored in a data lake associated with the threat detection data service 112 in order to generate one or more threat event record objects based on the one or more access threat detection jobs. In some contexts, the threat detection job service 114 is configured to facilitate the processing of the one or more portions of event data 122 stored in the data lake associated with the threat detection data service 112 via a communications network (e.g., network 124) associated with the threat detection management platform 104.

The threat detection stream service 116 associated with the threat detection management platform 104 may be configured to facilitate the transfer of one or more portions of data between various components of the threat detection management platform 104. For example, in various contexts, the threat detection stream service 116 is configured to aggregate, schedule, stage, queue, execute, initiate, and/or otherwise manage one or more portions of data for transferring to and/or from the threat detection data service 112, the threat detection job service 114, the threat detection model 118, and/or the threat detection computing device 120 of the threat detection management platform 104. In various embodiments, the threat detection stream service 116 integrates with a communication network associated with the threat detection management platform 104.

The threat detection model 118 refers to a machine learning (ML) model configured to detect and/or mitigate adverse impacts to a respective collaborative software application framework 102a. In various examples, the threat detection model 118 may be configured as an artificial intelligence (AI) model, rules-based model, artificial neural network (ANN), convolutional neural networks (CNN), recurrent neural networks (RNN), and/or any other type of specially trained model that is configured to detect and/or mitigate one or more access threats associated with a respective collaborative software application framework 102a. In various contexts, the one or more access threats may be caused by one or more of malware, spyware, automated bots, viruses, and/or bad actors attempting to access or crawl one or more portions of content data associated with the respective collaborative software application framework 102a. In various contexts, crawling the one or more portions of content data associated with the respective collaborative software application framework 102a includes accessing (e.g., viewing), exporting, importing, modifying, searching, and/or copying the one or more portions of content data.

The threat detection computing device 120 associated with the threat detection management platform 104 may be a combination of computer hardware and/or software that is configured to provide a service to a client device. In various examples, a threat detection computing device 120 may embody, be embodied by, interface with, integrate with, and/or otherwise be associated with a threat detection management platform 104. In some examples, a threat detection computing device 120 is configured to communicate with one or more client computing devices 106a-n using one or more computer networks.

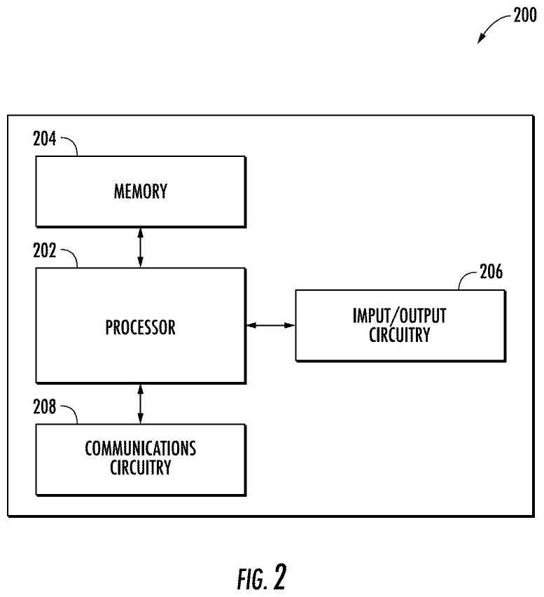

FIG. 2 illustrates a block diagram 200 of an exemplary threat detection computing device 120 structured in accordance with one or more embodiments of the present disclosure. The threat detection computing device 120 may be embodied by one or more computing systems. The threat detection computing device 120 may include processor 202, memory 204, input/output circuitry 206, and communications circuitry 208. The threat detection computing device 120 may be configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In various embodiments, the processor 202 may be configured to execute instructions stored in the memory 204 or otherwise accessible to the processor 202. In some non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the threat detection computing device 120 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the threat detection computing device 120. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of threat detection computing device 120. In some embodiments, one or more external systems (such as a remote cloud computing and/or data storage system) may also be leveraged to provide at least some of the functionality discussed herein.

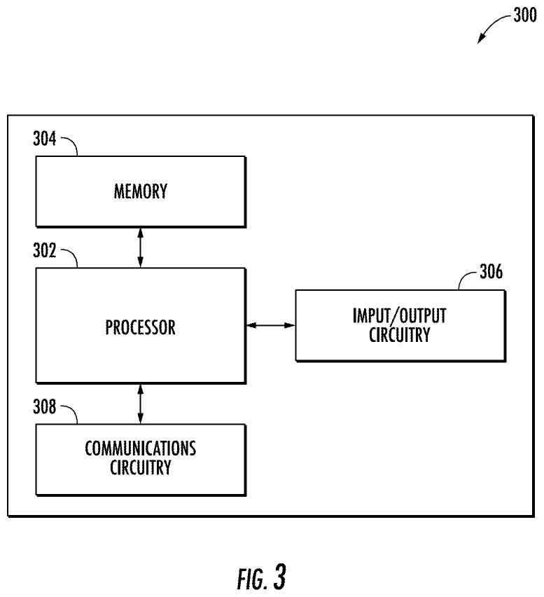

FIG. 3 illustrates a block diagram 300 of exemplary client computing device 106a structured in accordance with one or more embodiments of the present disclosure. The client computing device 106a may be embodied by one or more computing systems. The client computing device 106a may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the client computing device 106a to carry out various functions in accordance with example embodiments of the present invention.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some various embodiments, the processor 302 may be configured to execute instructions stored in the memory 304 or otherwise accessible to the processor 302. In some non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the client computing device 106a may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the client computing device 106a are embodied by a limited interaction device, the input/output circuitry 306 includes a touch screen and does not include, or at least does not operatively engage (i.e., when configured in a table mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the client computing device 106a. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of client computing device 106a. In some embodiments, one or more external systems (such as a remote cloud computing and/or data storage system) may also be leveraged to provide at least some of the functionality discussed herein.

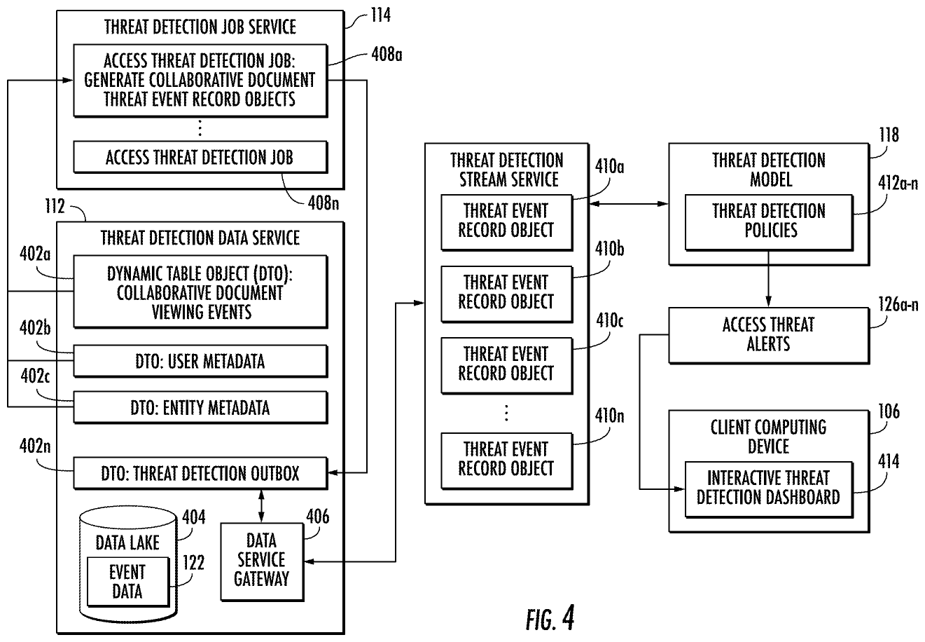

FIG. 4 illustrates a block diagram 400 of an exemplary threat detection management platform 104 structured in accordance with one or more embodiments of the present disclosure. Specifically, FIG. 4 illustrates the various data flows between the components of the threat detection management platform 104. As described herein, the threat detection management platform 104 comprises, integrates with, and/or otherwise employs a threat detection data service 112, a threat detection job service 114, a threat detection stream service 116, a threat detection model 118, and/or a threat detection computing device 120 to detect and/or mitigate one or more access threats for one or more collaborative software application frameworks 102a-n. For example, the threat detection management platform 104, in conjunction with the threat detection model 118, is configured to generate one or more access threat alerts 126a-n based on one or more threat event record objects 410a-n associated with the one or more collaborative software application frameworks 102a-n.

The threat detection management platform 104 is also configured to generate one or more interactive graphs, tables, notifications, and/or the like associated with the one or more access threat alerts 126a-n. In various contexts, the one or more interactive graphs, tables, alert notifications, and/or the like may be displayed via an interactive threat detection dashboard 414 rendered by one or more client computing devices 106a-n associated with the one or more collaborative software application frameworks 102a-n. Furthermore, the threat detection management platform 104 is configured to facilitate the routing and/or transmission of said alert notifications to one or more appropriate alert responder profiles (e.g., alert responder profiles associated with a respective alert response team) associated with the collaborative software application framework 102a.

As shown in FIG. 4, the threat detection data service 112 is configured to process one or more portions of event data 122 received from one or more respective collaborative software application frameworks 102a-n associated with the threat detection management platform 104. In various embodiments, the one or more portions of event data 122 are received from the one or more respective collaborative software application frameworks 102a-n via a communications network (e.g., network 124). Furthermore, the one or more portions of event data 122 are configured to be stored in a data lake 404 associated with the threat detection data service 112.

The threat detection data service 112 may also be configured to generate one or more dynamic table objects 402a-n, where the one or more dynamic table objects 402a-n are configurable data tables comprising a variable number of columns and/or rows. For example, the threat detection data service 112 is configured to generate one or more dynamic table objects 402a-n based on metadata associated with the event data 122 stored in the data lake 404. In various contexts, the one or more dynamic table objects 402a-n are generated based on an access threat detection job 408a being executed by a threat detection job service 114 associated with the threat detection management platform 104. Additionally, the one or more dynamic table objects 402a are configured to be generated, configured, edited, parsed, organized, searched, grouped, and/or the like based on one or more database commands issued by a respective computing device and/or service associated with the threat detection management platform 104.

In various examples, the one or more dynamic table objects 402a-n generated based on an access threat detection job 408a are each associated with a respective type of data and/or data category. For example, as shown in FIG. 4, the threat detection data service 112 may be configured to generate a first dynamic table object 402a associated with data related to one or more viewing events associated with one or more collaborative documents related to a respective collaborative work platform 107. The threat detection data service 112 may also be configured to generate a second dynamic table object 402b associated with various user metadata related to the respective collaborative work platform 107 (e.g., user identification data, account information, profile information, etc. related to an end user that has accessed the respective collaborative work platform 107). The threat detection data service 112 may also be configured to generate a third dynamic table object 402c associated with various entity metadata related to the respective collaborative work platform 107 (e.g., metadata associated with an enterprise related to the respective collaborative work platform 107). The threat detection data service 112 may also be configured to generate a fourth dynamic table object 402n associated with various combined data associated a respective access threat detection job (e.g., access threat detection job 408a) being executed by the threat detection job service 114.

In this regard, the threat detection data service 112 may be configured to execute various database commands with respect to the dynamic table objects 402a-n in order to parse, organize, search, group, and/or otherwise manipulate the data comprised in the dynamic table objects 402a-n in order to identify and/or generate one or more threat event record objects 410a-n. For example, the threat detection data service 112 is configured to generate one or more threat event record objects 410a-n based on one or more database commands executed by the threat detection job service 114, where the one or more threat event record objects 410a-n are generated based on event data 122 associated with one or more dynamic table objects 402a-n, and where the one or more database commands are executed based on an access threat detection job 408a being executed by a threat detection job service 114.

In various examples, the threat detection data service 112 embodies and/or integrates with a data service gateway 406. The data service gateway 406, in some embodiments, may be configured to receive and/or transmit data from one or more services, computing devices, and/or components associated with the threat detection management platform 104. For example, the data service gateway 406 is configured to receive and/or transmit one or more portion of event data 122 associated with one or more respective collaborative software application frameworks 102a-n. Additionally or alternatively, the data service gateway 406 is configured to receive one or more database commands to be executed by the threat detection data service 112 from the threat detection job service 114. Additionally or alternatively, the data service gateway 406 is configured to transmit one or more threat event record objects 410a-n generated by the threat detection data service 112 to a threat detection stream service 116 associated with the threat detection management platform 104.

The threat detection job service 114 may be configured to generate, schedule, queue, execute, initiate, and/or otherwise manage one or more access threat detection jobs 408a-n associated with the threat detection management platform 104. In various embodiments, the threat detection job service 114 is configured to generate, schedule, queue, execute, initiate, and/or otherwise manage the one or more access threat detection jobs 408a-n based on a predefined periodicity of time. In various examples, the one or more access threat detection jobs 408a-n may each be configured to facilitate the detection and/or identification of a particular type of access threat associated with one or more respective collaborative software application frameworks 102a-n.

For example, a first access threat detection job 408a may be associated with facilitating the detection, identification, and/or generation of one or more threat event record objects 410a-n related to the access and/or crawling of one or more collaborative documents associated with the one or more respective collaborative software application frameworks 102a-n. As another example, a second access threat detection job 408b may be associated with facilitating the detection, identification, and/or generation of one or more threat event record objects 410a-n related to the access and/or crawling of one or more issue tracking objects associated with the one or more respective collaborative software application frameworks 102a-n. As yet another example, a third access threat detection job 408c may be associated with facilitating the detection, identification, and/or generation of one or more threat event record objects 410a-n related to the access and/or crawling of one or more code repositories associated with the one or more respective collaborative software application frameworks 102a-n. As yet another example, a third access threat detection job 408c may be associated with facilitating the detection, identification, and/or generation of one or more threat event record objects 410a-n related to the access and/or crawling of one or more restricted pages associated with the one or more respective collaborative software application frameworks 102a-n.

As shown in FIG. 4, the threat detection job service 114 is configured to work in conjunction with the threat detection data service 112 in order to generate one or more threat event record objects 410a-n based on the one or more access threat detection jobs 408a-n. For example, the threat detection job service 114 is configured to facilitate the processing of one or more portions of event data 122 stored in a data lake 404 associated with the threat detection data service 112 in order to generate one or more threat event record objects 410a-n based on the one or more access threat detection jobs 408a-n. In some contexts, the threat detection job service 114 is configured to facilitate the processing of the one or more portions of event data 122 stored in the data lake 404 associated with the threat detection data service 112 via a communications network (e.g., network 124) associated with the threat detection management platform 104.

For example, the threat detection job service 114 is configured to facilitate the processing of one or more portions of event data 122 stored in a data lake 404 associated with the threat detection data service 112 in order to identify and/or generate one or more threat event record objects 410a-n based on the one or more access threat detection jobs 408a-n. A particular access threat detection job 408a may be associated with a specific data source and/or type of content data of associated with a respective collaborative work platform 107, service-oriented platform 108, and/or monolithic platform 110 related to a respective collaborative software application framework 102a. For example, a particular access threat detection job 408a may be configured to facilitate the processing of event data 122 to generate threat event record objects 410a-n related to one or more collaborative documents associated with a collaborative work platform 107 related to a collaborative software application framework 102a.

The one or more threat event record objects 410a-n may comprise various data, information, text, and/or other media used to describe a potential threat associated with a collaborative software application framework 102a. A threat event record object 410a is generated based on an access threat detection job 408a initiated by the threat detection job service 114 associated with the threat detection management platform 104, where the threat detection job service 114 is configured to facilitate the processing of one or more portions of event data 122 stored in a data lake 404 associated with the threat detection data service 112. In various examples, a threat event record object 410a may describe a potential threat (e.g., a data crawling threat) that may adversely impact the operation of a respective collaborative software application framework 102a. In various contexts, a threat event record object 410a may describe a potential threat that is currently impacting a respective collaborative software application framework 102a (e.g., in real time or near-real time), or a potential threat that has occurred with related to a respective collaborative software application framework 102a in the past.

In some examples, a threat event record object 410a threat event record object 410a describes an access pattern associated with an entity, where the access pattern is associated with an access to one or more components associated with the collaborative software application framework 102a by the entity. For example, an access pattern associated with a respective threat event record object 410a may describe that Entity A is viewing (e.g., accessing) more than X pages (e.g., collaborative documents) per Y minutes. As another example, an access pattern associated with a respective threat event record object 410a may describe that Entity A is viewing (e.g., accessing) more than X restricted pages (e.g., private documents) per Y minutes. As another example, an access pattern associated with a respective threat event record object 410a may describe that Entity B is exporting more than X pages (e.g., collaborative documents) in Y minutes. As another example, an access pattern associated with a respective threat event record object 410a may describe that Entity B is exporting more than X collaborative workspaces in Y minutes.

As shown in FIG. 4, the data service gateway 406 may be configured to transmit one or more threat event record objects 410a-n generated by the threat detection data service 112 to a threat detection stream service 116 associated with the threat detection management platform 104. In various contexts, the threat detection stream service 116 is configured to aggregate, schedule, stage, queue, execute, initiate, and/or otherwise manage one or more portions of data for transferring to and/or from the threat detection data service 112, the threat detection job service 114, the threat detection model 118, and/or the threat detection computing device 120 of the threat detection management platform 104. In various embodiments, the threat detection stream service 116 integrates with a communications network (e.g., network 124) associated with the threat detection management platform 104.

For example, the threat detection stream service 116 may be configured to retrieve and/or receive one or more threat event record objects 410a-n from the threat detection data service 112 (e.g., via the data service gateway 406). In various contexts, the threat detection stream service 116 may be configured to retrieve and/or receive the one or more threat event record objects 410a-n from the threat detection data service 112 based on a predetermined periodicity of time (e.g., as configured by the threat detection computing device). In some contexts, the threat detection stream service 116 is configured to transmit the one or more threat event record objects 410a-n to the threat detection model 118. For example, the threat detection stream service 116 may be configured to compile and/or a transmit a batch of threat event record objects 410a-n associated with a plurality of collaborative software application frameworks 102a-n related to various respective clients (e.g., respective individuals, companies, enterprises, and/or other organizational structures), and transmit the batch of threat event record objects 410a-n the threat detection model 118.

In various embodiments, the threat detection model 118 employs one or more threat detection policies 412a-n configured to detect one or more access threats impacting a respective collaborative software application framework 102a. The threat detection model 118 determines which of the one or more threat detection policies 412a-n to employ based on one or more threat event record objects 410a-n received from the threat detection stream service 116. In various contexts, the threat detection model 118 is configured to determine (e.g., by way of a respective threat detection policy 412a) whether an access pattern associated a threat event record object 410a satisfies at least one access threshold parameter of a plurality of access threshold parameters. In response to determining that the access pattern associated with the threat event record object 410a satisfies the at least one access threshold parameter, the threat detection model 118 is configured to generate an access threat alert 126a associated with the collaborative software application framework 102a.

Additionally, in some embodiments, the threat detection model 118 is configured to assign a severity level to a respective access threat alert 126a based on the threat detection policy 412a used to generate the access threat alert 126a and/or or the access pattern associated with the threat event record object 410a that triggered the generation of the access threat alert 126a. Furthermore, in various contexts, the threat detection model 118 configured to cause display of the access threat alert 126a via an interactive threat detection dashboard 414 rendered on a client computing device 106a associated with the collaborative software application framework 102a.

In various embodiments, a plurality of threat detection policies 412a-n may be associated with a plurality of respective clients, where the plurality of clients is associated with a plurality of collaborative software application frameworks 102a-n, where each threat detection policy of the plurality of threat detection policies 412a-n is associated with one or more respective access threshold parameters. In some embodiments, the one or more respective access threshold parameters associated with the at least one threat detection policy 412a are configured by a first client of the plurality of clients via the interactive threat detection dashboard 414.

As such, in various embodiments, one or more threat detection policies 412a-n may be client-specific and configured based on various threat detection policy data associated with the respective clients of the plurality of clients. In this regard, the threat detection model 118 may be trained based on various threat detection policy data (e.g., associated with the plurality of threat detection policies 412a-n) associated with a plurality of clients and applied to one or more threat event record objects 410a-n in order to generate one or more access threat alerts 126a-n for the plurality of clients. Additionally or alternatively, in various embodiments, the one or more threat detection policies 412a-n may comprise one or more default threat detection policies associated with the threat detection management platform 104. For example, a generic threat detection policy may be configured to generate various access threat alerts 126a-n based on default access threshold parameters (e.g., based on a predefined number of page views within a certain period of time).

In some examples, a threat detection policy 412a is comprised of one or more portions of executable computer program code that is configured to process one or more threat event record objects 410a-n to identify a potential source of risk associated with one or more respective collaborative software application frameworks 102a-n and whether to generate one or more corresponding access threat alerts 126a-n. In various embodiments, threat detection policy 412a associated with a threat detection model 118 is configured to receive one or more threat event record objects 410a-n as model input and generate one or more access threat alerts 126a-n as model output.

In various contexts, a respective threat detection policy 412a may be employed to determine whether an access pattern associated a threat event record object 410a satisfies at least one access threshold parameter of a plurality of access threshold parameters. In various examples, an access threshold parameter is associated with at least one of a view count, a view duration, a modification count, modification amount, export count, export amount, import count, and/or import amount associated with at least one portion of content data associated with a respective collaborative software application framework 102a. Additionally, an access threshold parameter may be associated with a predetermined time interval used to determine whether an access pattern associated with a respective threat event record object 410a satisfies (e.g., exceeds) the access threshold parameter. In response to determining that the access pattern associated with the threat event record object 410a satisfies the at least one access threshold parameter, the threat detection policy 412a may direct that threat detection model 118 to generate an access threat alert 126a associated with the collaborative software application framework 102a.

In various embodiments, a respective access threat alert 126a may be configured to comprise various data, information, text, and/or other media used to describe a respective access threat and/or incident associated with a collaborative software application framework 102a. As such, access threat alerts 126a-n are configured to describe whether a collaborative software application framework 102a (e.g., a collaborative work platform 107, service-oriented platform 108, and/or monolithic platform 110 associated with the collaborative software application framework 102a) is currently being accessed and/or has been accessed in the past in a suspicious manner.

For example, in various contexts, an access threat alert 126a may indicate that one or more portions of content data associated with a collaborative software application framework 102a (e.g., a collaborative work platform 107, service-oriented platform 108, and/or monolithic platform 110 associated with the collaborative software application framework 102a) is currently being crawled and/or has potentially been crawled in the past (e.g., by an automated bot, malware, spyware, virus, bad actor, and/or the like). A respective access threat alert 126a may also describe an impact to the operating functionality of the collaborative software application framework 102a. Such operating functionality may include indicators regarding the performance of the collaborative software application framework 102a (e.g., whether the various components of the collaborative software application framework 102a are running at peak speed or slower than peak speed, if certain functions or capabilities are not running at peak performance or are not running at all, etc.).

In various embodiments, access threat alerts 126a-n are associated with one or more alert attributes including at least one of an alert severity, an alert identifier, an access threat alert type, an alert description, an alert data source, an alert timestamp, an alert responder profile, an alert mitigation status, or an alert mitigation ticket. Access threat alerts 126a-n and/or one or more portions of data related to access threat alerts 126a-n may be generated and/or received by the threat detection management platform 104 (e.g., via the threat detection model 118) and stored in a data lake 404 associated with the threat detection data service 112. In various contexts, access threat alerts 126a-n may be used by the threat detection management platform 104 to generate and/or cause the transmission of one or more notifications (e.g., via an interactive threat detection dashboard 414).

Furthermore, one or more portions of data associated with the access threat alerts 126a-n may be used to generate one or more interactive interface elements associated with the interactive threat detection dashboard 414 including one or more interactive graphs, tables, diagrams, images, links, and/or the like that can be used to diagnose and/or analyze the performance of one or more collaborative software application frameworks 102a-n. Additionally, in various examples, an access threat alert 126a is associated with a threat detection payload, where the threat detection payload is associated with at least one portion of content data of the collaborative software application framework 102a. In various contexts, the at least one portion of content data corresponds to an access threat alert 126a type associated with the one access threat alert 126a.

In addition to causing generation of one or more access threat alerts 126a-n associated with a collaborative software application framework 102a, the threat detection model 118 may employ one or more threat detection policies 412a-n to make various decisions and/or cause execution of various actions. For example, in some contexts, the threat detection model 118 employs the one or more threat detection policies 412a-n to decide whether to generate an access threat alert 126a for each respective threat event record object 410a of the one or more threat event record objects 410a-n received from the threat detection stream service 116. As another example, in some contexts, the threat detection model 118 employs the one or more threat detection policies 412a-n to decide whether to generate a single access threat alert 126a based on a combination of the one or more threat event record objects 410a-n received from the threat detection stream service 116.

In some embodiments, a threat detection policy 412a employed by the threat detection model 118 is generated based at least in part on at least one portion of client input data received via the interactive threat detection dashboard 414. For example, an end user associated with a respective client computing device 106a can generate one or more threat detection policies 412a-n by inputting client input data via the interactive threat detection dashboard 414. In various contexts, client input data associated with the threat detection policy 412a being generated may include description data, severity data, category data, cadence data, schedule interval data, and/or trigger data.

### Operational Examples of the Disclosure

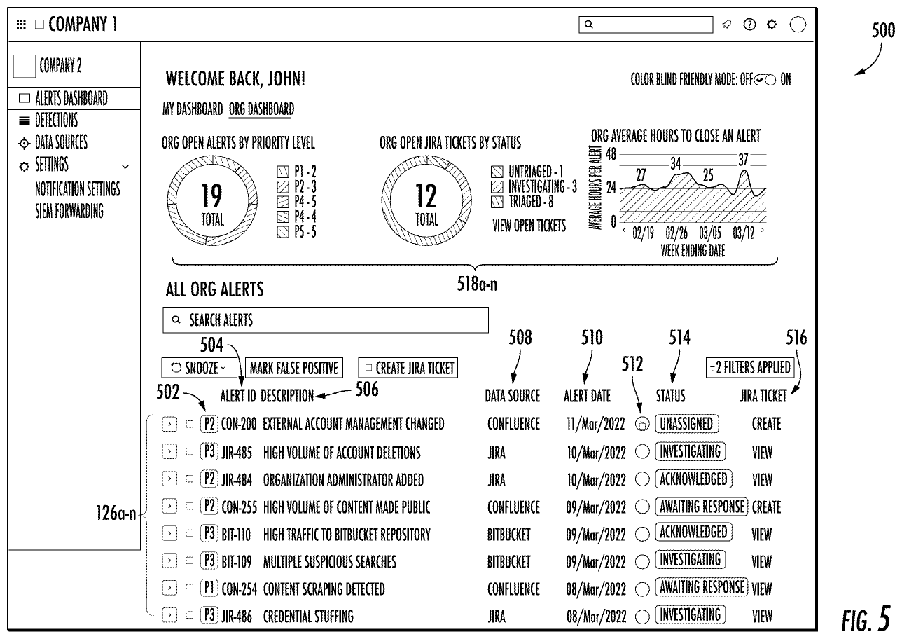

FIG. 5 illustrates an operational example of a user interface 500 of an interactive threat detection dashboard 414 in accordance with one or more embodiments of the present disclosure. Specifically, FIG. 5 shows a configuration of the interactive threat detection dashboard 414 rendered by the threat detection management platform 104 that enables the viewing of various portions of data related to one or more access threat alerts 126a-n. As described herein, in various embodiments, one or more access threat alerts 126a-n may be associated with one or more alert attributes including at least one of an alert severity 502, an alert identifier 504, an access threat alert type, an alert description 506 describing the access threat alert type of a corresponding access threat alert 126a, an alert data source 508, an alert timestamp 510, an alert responder profile 512, an alert mitigation status 514, and/or an alert mitigation ticket 516. Additionally, as shown in FIG. 5, one or more portions of data associated with the access threat alerts 126a-n may be used to generate one or more interactive interface elements 518a-n associated with the interactive threat detection dashboard 414 including one or more interactive graphs, tables, diagrams, images, links, and/or the like that can be used to diagnose and/or analyze the performance of one or more collaborative software application frameworks 102a-n being monitored by the threat detection management platform 104.

In various embodiments, the alert severity 502 may be assigned to a respective access threat alert 126a by the threat detection model 118 associated with the threat detection management platform 104. For example, the threat detection model 118 may be configured to assign a severity level to a respective access threat alert 126a based on a respective threat detection policy 412a that was used to generate the access threat alert 126a. Additionally, in some embodiments, the alert severity 502 may be assigned to the respective access threat alert 126a by the threat detection model 118 based on an access pattern associated with the threat event record object 410a that triggered the generation of the respective access threat alert 126a.

The alert identifier 504 refers to one or more items of data by which an access threat alert 126a may be identified within a threat detection management platform 104. For example, an alert identifier may comprise text string(s), numerical character(s), alphabetical character(s), alphanumeric code(s), ASCII character(s), a pointer, an IP address, a MAC address, a memory address, other unique identifier, or a combination thereof.

The alert description 506 describes the access threat alert type of a corresponding access threat alert 126a. The access threat alert type refers to one or more items of data by which an access threat alert type may be identified within a threat detection management platform 104. Access threat alert types include a collaborative document alert type, an issue tracking alert type, a suspicious search alert type, an administrative account alert type, or a code repository alert type.

The collaborative document alert type is associated with at least one of an unusual page activity alert associated with a respective collaborative document, a mass page export alert associated with one or more respective collaborative documents, a restricted document access alert, an unauthorized user access alert, or an alert associated with a high volume of collaborative document content being made public. The issue tracking alert type is associated with at least one of a mass issue tracking object export alert or unusual issue activity associated with one or more issue tracking objects. The administrative account alert type is associated with at least one of an administrative account change alert, an external access granted alert, a security assertion markup language (SAML) alert, an administrative account application programming interface (API) token change alert, or alert associated with a connection of an administrative account to an external third-party service. The code repository alert type is associated with at least one of a mass code repository clone alert, a mass code repository export alert, or a mass code repository commit alert.

The alert data source 508 may be associated with a service (e.g., feature, application, product, etc.) associated with a collaborative software application framework 102a in which the access threat associated with a respective access threat alert 126a occurred. In some embodiments, the alert data source 508 may comprise data indicating the upstream and downstream services for each specific service associated with the collaborative software application framework 102a. In some embodiments, the alert data source 508 may comprise service tier level data to indicate the importance of the service (e.g., the importance of the service to an enterprise and/or end user using the collaborative software application framework) for the user of the collaborative software application framework 102a (e.g., the collaborative work platform 107, the service-oriented platform 108, and/or the monolithic platform 110). In some embodiments, the alert data source 508 may comprise data associated with other alert data sources which may indicate the number of impacted services from an access threat alert 126a of a specific service. In some embodiments, a particular alert data source 508 (e.g., and therefore a particular service) may be associated with specific alert responder profile 512 within a collaborative software application framework 102a.

The alert responder profile 512 refers to one or more entities associated with one or more respective personnel and/or responsible parties related to a collaborative software application framework 102a that are intended to receive, review, acknowledge, mitigate, and/or otherwise manage access threat alerts 126a-n associated with the collaborative software application framework 102a. In various embodiments, an alert responder profile 512 is associated with one or more entities associated with one or more alert response teams, alert response services (e.g. third-party alert response services), and/or any other entity capable of receiving, reviewing, acknowledging, mitigating, and/or otherwise managing access threat alerts 126a-n.

In various embodiments, a respective alert response team related to a respective collaborative software application framework 102a may be associated with one or more alert responder profiles, developer profiles, management profiles, administrative profiles, IT assistance profiles, help desk profiles, and/or the like. In such embodiments, the one or more profiles associated with the alert response team may be associated with a respective hierarchy, a specific level of access permissions, and/or a respective priority level. In various examples, the one or more profiles associated with the alert response team may be associated with one or more respective client computing devices 106a-n. In one or more embodiments, one or more alert responder profiles 512 may be embodied by, integrated with, and/or otherwise associated with one or more respective third-party alert response services (e.g., cloud-based alert mitigation services, cloud-based alert data storage platforms, and/or the like) associated with the collaborative software application framework 102a. The threat detection management platform 104 may be configured to determine one or more alert responder profiles 512 that have access permissions to view and/or receive data associated with one or more respective access threat alerts 126a-n and/or one or more notifications associated with the one or more respective access threat alerts 126a-n.

In some embodiments, the alert mitigation status 514 describes a current status associated with a respective access threat alert 126a. For example, the alert mitigation status 514 may described that the access threat alert is “unassigned” (e.g., the threat detection management platform 104 has generated an access threat alert 126a which has not yet been assigned to a respective alert responder profile 512), “untriaged” (e.g., a respective alert responder profile 512 has been assigned, but has not yet started investigating the access threat alert 126a), “investigating” (e.g., an alert responder profile 512 has started to investigate the access threat alert 126a), “triaged” (e.g., an alert responder profile 512 has completed an investigation of the access threat alert 126a but has not marked the access threat alert 126a as completed), or “closed” (e.g., an alert responder profile 512 has completed an investigation of the access threat alert 126a and has marked the access threat alert 126a as completed).

The alert mitigation ticket 516 associated with a respective access threat alert 126a may be an issue tracking object configured to track a mitigation progress of the respective access threat alert 126a. The interactive threat detection dashboard 414 may be configured to indicate whether an alert mitigation ticket 516 has been generated for a respective access threat alert 126a. The interactive threat detection dashboard 414 may also be configured to enable one or more alert responder profiles 512 to view an alert mitigation ticket 516 associated with a respective access threat alert 126a. The interactive threat detection dashboard 414 may also be configured to enable one or more alert responder profiles 512 to cause the generation of an alert mitigation ticket 516 associated with a respective access threat alert 126a.

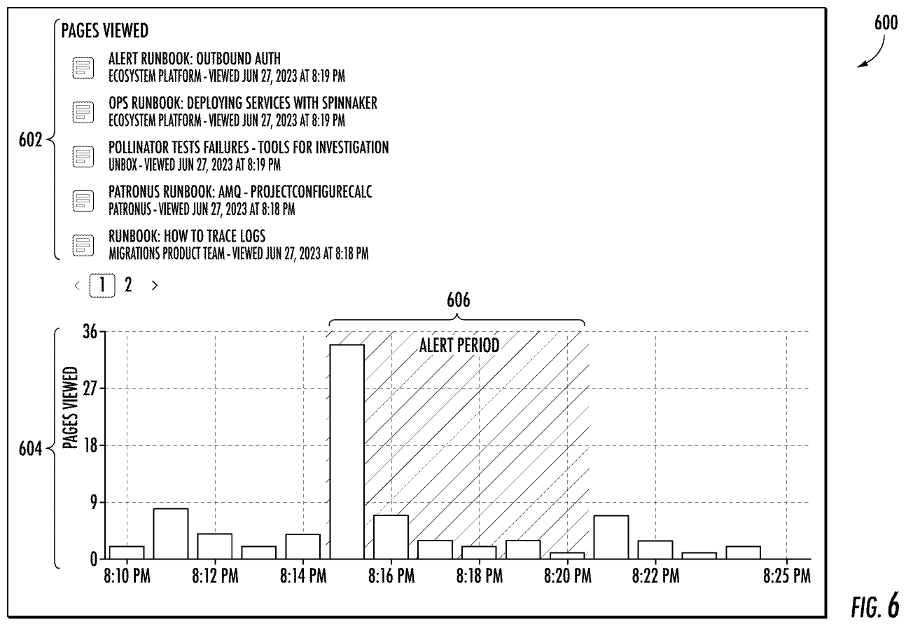

FIG. 6 illustrates an operational example of a user interface 600 of an interactive threat detection dashboard 414 configured to render additional detailed information related to a respective access threat alert 126a in accordance with one or more embodiments of the present disclosure. Specifically, FIG. 6 illustrates that the interactive threat detection dashboard 414 may be configured to display data related to a threat detection payload 602 and an interactive interface element 604 configured as a bar graph.

As described herein, in various examples, an access threat alert 126a may be associated with a threat detection payload 602, where the threat detection payload 602 is associated with at least one portion of content data of the collaborative software application framework 102a. In various contexts, the at least one portion of content data corresponds to an access threat alert type associated with the respective access threat alert 126a. For example, as shown in FIG. 6, the threat detection payload 602 comprises data related to the various pages that were accessed (e.g., viewed) by an entity (e.g., end user, automated bot, etc.), thus triggering the generation of a threat event record object 410a and, subsequently, the generation of an access threat alert 126a by the threat detection management platform 104. The threat detection payload 602 comprises data related to the titles, contents, data sources, and timestamps of the pages accessed by the entity. In various embodiments, the threat detection payload 602 may comprise one or more hyperlinks associated with the pages that were accessed by the entity.

The interactive interface element 604 configured as a bar chart is rendered via the interactive threat detection dashboard 414 in order to visualize one or more portions of data related to the accessing of one or more pages associated with the collaborative software application framework 102a by the entity. In various embodiments, the interactive interface element 604 may be configured to describe one or more portions of data related to the threat detection payload 602 associated with the respective access threat alert 126a. Additionally or alternatively, the interactive interface element 604 may be configured to described one or more portions of data related to the one or more threat event record objects 410a-n based upon which the respective access threat alert 126a was generated. For example, the interactive interface element 604 may be configured to described one or more portions of data related to an access pattern associated with the one or more threat event record objects 410a-n.

Additionally or alternatively, the interactive interface element 604 may be configured to described one or more portions of data related to one or more access threshold parameters being evaluated by a respective threat detection policy 412a in order to generate the respective access threat alert 126a. For example, time interval 606 may be associated with an access threshold parameter used to determine whether an access pattern associated with a respective threat event record object 410a satisfies (e.g., exceeds) the access threshold parameter.

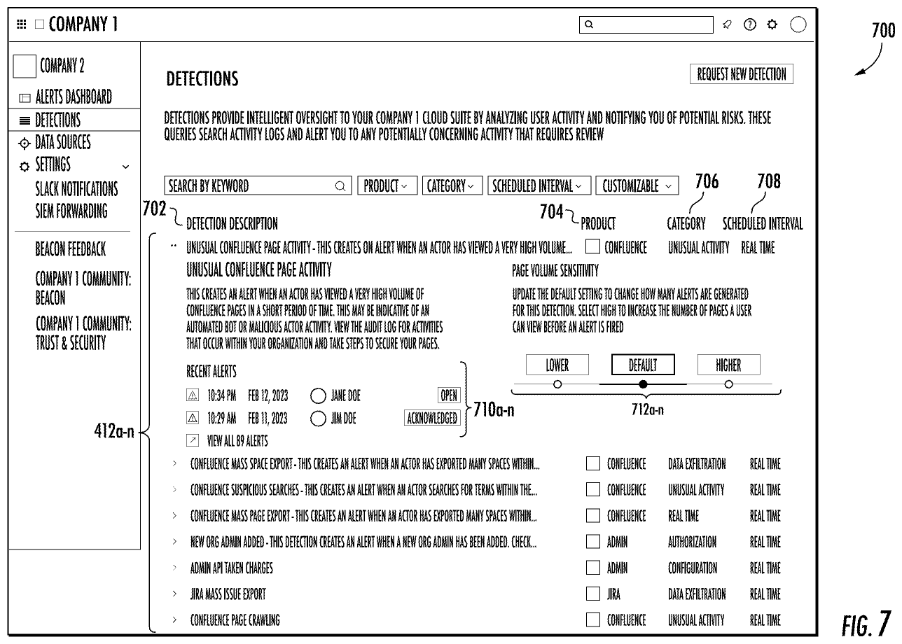

FIG. 7 illustrates an operational example of a user interface 700 of an interactive threat detection dashboard 414 configured to display data associated with one or more threat detection policies 412a-n in accordance with one or more embodiments of the present disclosure. Specifically, FIG. 7 illustrates that the interactive threat detection dashboard 414 may be configured to allow an alert responder profile 512 to view and/or edit one or more threat detection policies 412a-n to be employed by a threat detection model 118 associated with the threat detection management platform 104. As shown in FIG. 7, the user interface 700 depicts a threat detection policy description 702, an alert data source 704, an alert category 706, a scheduled interval 708, one or more recent access threat alerts 710a-n, and one or more interactive interface elements 712a-n associated with one or more respective threat detection policies 412a-n.

In various embodiments, the threat detection policy description 702 associated with a respective threat detection policy 412a describes the conditions for which one or more access threat alerts 126a-n may be generated. In some embodiments, the threat detection policy description 702 may also comprise one or more operations, tasks, and/or actions to be taken in response to the access threat alert 126a. In some embodiments, the alert data source 704 may be associated with a service (e.g., feature, application, product, etc.) associated with a collaborative software application framework 102a for which the threat detection policy 412a is configured to facilitate the generation of one or more access threat alerts 126a-n. In some embodiments, the alert category 706 is associated with a particular access threat alert type that the threat detection policy 412a is configured to detect. As described herein, various access threat alert types associated with the threat detection management platform 104 may comprise at least one of a collaborative document alert type, an issue tracking alert type, a suspicious search alert type, an administrative account alert type, or a code repository alert type.

The scheduled interval 708 may be associated with a recurring periodicity of time for which the threat detection model 118 is to employ a respective threat detection policy 412a. For example, the scheduled interval 708 may cause the threat detection model 118 to employ the respective threat detection policy 412a for a particular collaborative software application framework 102a every 12 hours. In various embodiments, the scheduled interval 708 may be configured via the interactive threat detection dashboard 414 to be associated with any recurring periodicity of time (e.g., every 1 minute, 1 hour, 12 hours, 24 hours, etc.).

Additionally, as illustrated in FIG. 7, the user interface 700 of the interactive threat detection dashboard 414 may display one or more recently generated access threat alerts 710a-n that have been generated based on a respective threat detection policy 412a. For example, the one or more recently generated access threat alerts 710a-n may give a data snapshot comprising information related to a respective access threat alert 126a that was generated and may include an alert timestamp 510, an alert responder profile 512, and/or an alert mitigation status 514.

Additionally, as illustrated in FIG. 7, the user interface 700 of the interactive threat detection dashboard 414 may be configured to display one or more interactive interface elements 712a-n associated with a respective threat detection policy 412a, where the one or more interactive interface elements 712a-n are configured to adjust one or more access threshold parameters. For example, based on an interaction with the one or more interactive interface elements 712a-n, an alert responder profile 512 may be enabled to adjust an access threshold parameter related to a number of pages an entity can view before a respective access threat alert 126a is generated. Such adjustments may affect the number of access threat alerts 126a-n generated based on the respective threat detection policy 412a.

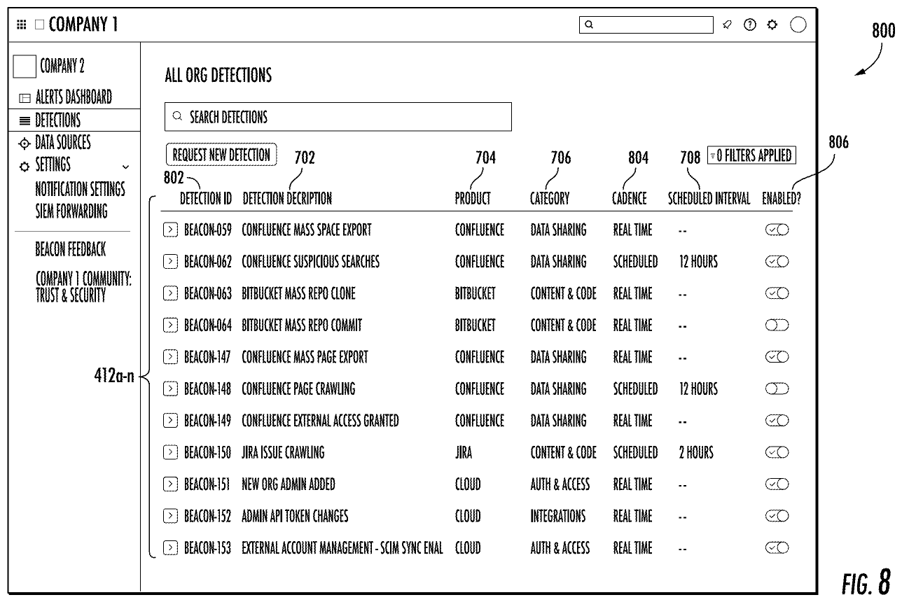

FIG. 8 illustrates another operational example of a user interface 800 of an interactive threat detection dashboard 414 configured to display data associated with one or more threat detection policies 412a-n in accordance with one or more embodiments of the present disclosure. Specifically, FIG. 8 illustrates that the interactive threat detection dashboard 414 may be configured to allow an alert responder profile 512 to view and/or edit one or more threat detection policies 412a-n to be employed by a threat detection model 118 associated with the threat detection management platform 104. As shown in FIG. 8, the user interface 800 depicts that a respective threat detection policy 412a may be associated with a detection identifier 802, a detection cadence 804, and/or an interactive interface element 806 configured to enable or disable the respective threat detection policy 412a. As shown by the user interface 800, the detection identifier 802, the detection cadence 804, and/or the interactive interface element 806 may be displayed in addition to the threat detection policy description 702, the alert data source 704, the alert category 706, the scheduled interval 708, the one or more recent access threat alerts 710a-n, and/or the one or more interactive interface elements 712a-n associated with one or more respective threat detection policies 412a-n.

In various embodiments, the detection cadence 804 associated with a respective threat detection policy 412a determines the periodicity for which the threat detection model 118 is to employ the respective threat detection policy 412a. For example, the detection cadence 804 may direct the threat detection model 118 to employ the respective threat detection policy 412a with a real-time cadence or a scheduled cadence. If the respective threat detection policy 412a is associated with a detection cadence 804 configured as a real-time cadence, the threat detection model 118 may employ the respective threat detection policy 412a to generate access threat alerts 126a-n in real-time (e.g., for access threats that are currently impacting a respective collaborative software application framework 102a). Alternatively, if the respective threat detection policy 412a is associated with a detection cadence 804 configured as a scheduled cadence, the threat detection model 118 may employ the respective threat detection policy 412a according to a scheduled interval 708 associated with the respective threat detection policy 412a.

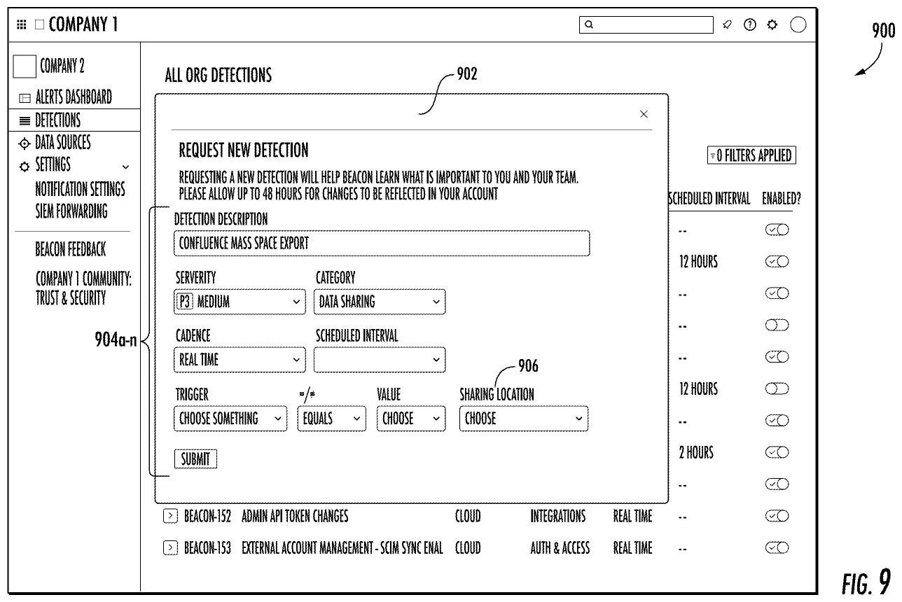

FIG. 9 illustrates an operational example of a user interface 900 of an interactive threat detection dashboard 414 configured to generate a threat detection policy 412a in accordance with one or more embodiments of the present disclosure. Specifically, FIG. 9 illustrates that the interactive threat detection dashboard 414 may be configured to generate one or more sub-interfaces in order to facilitate one or more of the techniques described herein. For example, as shown in FIG. 9, the interactive threat detection dashboard 414 may be configured to generate a sub-interface 902 to facilitate the generation of a new threat detection policy 412a to be employed by the threat detection model 118.

In various embodiments, the sub-interface 902 may comprises one or more interactive interface elements 904a-n configured to facilitate to the generation of a respective threat detection policy 412a. The one or more interactive interface elements 904a-n may be configured to define one or more parameters associated with the respective threat detection policy 412a. For example, the one or more interactive interface elements 904a-n may be configured to define a threat detection policy description (e.g., threat detection policy description 702), an alert category (e.g., alert category 706), a detection cadence (e.g., detection cadence 804), and/or a scheduled interval (e.g., scheduled interval 708). In some embodiments, the interactive interface elements 904a-n may also be configured to define a respective alert severity associated with one or more access threat alerts 126a-n to be generated based on the respective threat detection policy 412a. Additionally or alternatively, interactive interface elements 904a-n may also be configured to define one or more access threshold parameters to be used in triggering the generation of one or more access threat alerts 126a-n to be generated based on the respective threat detection policy 412a.

The depicted sub-interface 902 includes a sharing location interface element 906 among the one or more interface elements 904a-n. The sharing location interface element 906 is configured, when engaged by a user, to allow user pre-selection of a communication channel (e.g., email, dashboard, Slack channel, Microsoft Teams communication, direct message, etc.) for outputting alerts or other communications associated with the respective thread detection policy 412a that is defined by user engagement with sub-interface 902.

### Example Processes of the Disclosure

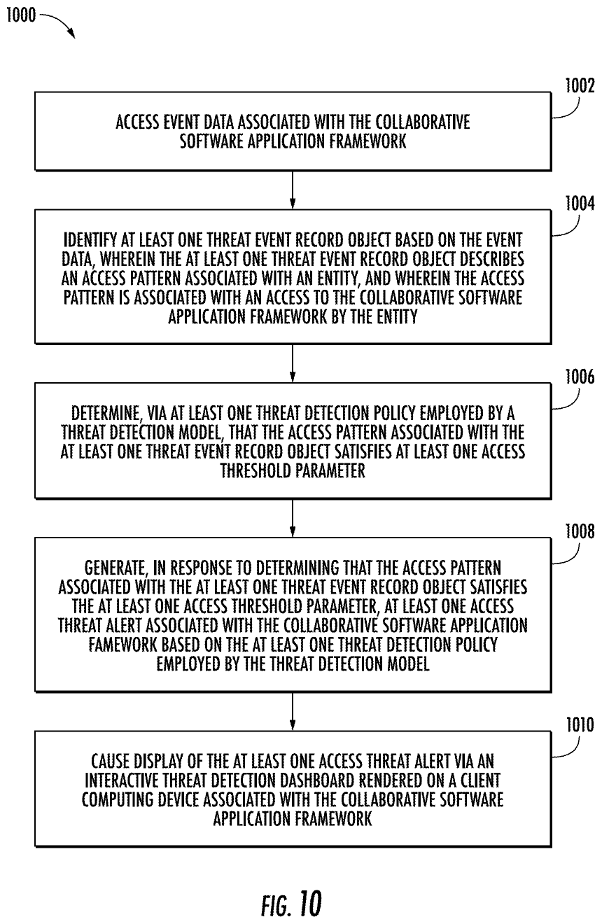

FIG. 10 illustrates a flowchart representing a method for performing enhanced threat detection for one or more collaborative software applications in accordance with one or more embodiments of the present disclosure. In some embodiments, the method 1000 is embodied by computer program code stored on a non-transitory computer-readable storage medium of a computer program product configured for execution to perform the process as depicted and described. Additionally or alternatively, in some embodiments, the method 1000 is performed by one or more specially configured computing devices, such as the threat detection computing device 120 alone or in communication with one or more other components, devices, and/or systems (e.g., a threat detection management platform 104).

In this regard, the threat detection computing device 120 may be specially configured by computer-coded instructions (e.g., computer program instructions) stored thereon, for example in the memory 204 and/or another component depicted and/or described herein and/or otherwise accessible to the threat detection computing device 120, for performing the operations as depicted and described. In some embodiments, the threat detection computing device 120 is in communication with one or more external apparatuses, systems, devices, and/or the like, to perform one or more of the operations as depicted and described. For purposes of simplifying the description, the method 1000 is described as performed by and from the perspective of the threat detection computing device 120.

The method 1000 begins at operation 1002. At operation 1002, the threat detection computing device 120 includes means such as the communications circuitry 208, input/output circuitry 206, memory 204, and/or processor 202, or any combination thereof, that accesses event data 122 associated with a collaborative software application framework 102a. In various embodiments, the event data 122 is configured to be stored in a data lake 404 associated with a threat detection data service 112 related to the threat detection management platform 104. Event data 122 may be associated with various portions of metadata related to any respective user input data, user access data, and/or user interactions associated with a collaborative work platform 107, service-oriented platform 108, and/or monolithic platform 110 related to the respective collaborative software application framework 102a.

For example, event data 122 can be associated with an access, or “view”, of a respective page and/or portion of content data (e.g., a collaborative document, a restricted document, a collaborative workspace, an issue tracking object, a webpage, a computer program code repository, administrative account data, a datastore, etc.) associated with a respective collaborative software application framework 102a by a computing device. Additionally or alternatively, event data 122 can be associated with an export of a respective page and/or portion of content data associated with a respective collaborative software application framework 102a by a computing device. Additionally or alternatively, event data 122 can be associated with an import of a respective page and/or portion of content data associated with a respective collaborative software application framework 102a by a computing device. Additionally or alternatively, event data 122 can be associated with a modification of a respective page and/or portion of content data associated with a respective collaborative software application framework 102a by a computing device.

At operation 1004, the threat detection computing device 120 includes means such as the communications circuitry 208, input/output circuitry 206, memory 204, and/or processor 202, or any combination thereof, that identifies at least one threat event record object 126a based on the event data 122, where the at least one threat event record object 410a describes an access pattern associated with an entity, and wherein the access pattern is associated with an access to the collaborative software application framework 102a by the entity. In this regard, the threat detection data service 112 may be configured to execute various database commands with respect to the dynamic table objects 402a-n in order to parse, organize, search, group, and/or otherwise manipulate the data comprised in the dynamic table objects 402a-n in order to generate one or more threat event record objects 410a-n. For example, the threat detection data service 112 is configured to generate one or more threat event record objects 410a-n based on one or more database commands executed by the threat detection job service 114, where the one or more threat event record objects 410a-n are generated based on event data 122 associated with one or more dynamic table objects 402a-n, and where the one or more database commands are executed based on an access threat detection job 408a being executed by a threat detection job service 114.

In some examples, a threat event record object 410a threat event record object 410a describes an access pattern associated with an entity, where the access pattern is associated with an access to one or more components associated with the collaborative software application framework 102a by the entity. For example, an access pattern associated with a respective threat event record object 410a may describe that Entity A is viewing (e.g., accessing) more than X pages (e.g., collaborative documents) per Y minutes. As another example, an access pattern associated with a respective threat event record object 410a may describe that Entity A is viewing (e.g., accessing) more than X restricted pages (e.g., private documents) per Y minutes. As another example, an access pattern associated with a respective threat event record object 410a may describe that Entity B is exporting more than X pages (e.g., collaborative documents) in Y minutes. As another example, an access pattern associated with a respective threat event record object 410a may describe that Entity B is exporting more than X collaborative workspaces in Y minutes.

At operation 1006, the threat detection computing device 120 includes means such as the communications circuitry 208, input/output circuitry 206, memory 204, and/or processor 202, or any combination thereof, that determines, via at least one threat detection policy 412a employed by a threat detection model 118, that the access pattern associated with the at least one threat event record object 410a satisfies at least one access threshold parameter. In some embodiments, the at least one threat event record object 410a is a first threat event record object of a batch of threat event record objects 410a-n, where the batch of threat event record objects is associated with a plurality of collaborative software application frameworks 102a-n, and where the threat detection model 118 is applied to the batch of threat event record objects 410a-n.

In various examples, an access threshold parameter is associated with at least one of a view count, a view duration, a modification count, modification amount, export count, export amount, import count, and/or import amount associated with at least one portion of content data associated with a respective collaborative software application framework 102a. Additionally, an access threshold parameter may be associated with a predetermined time interval used to determine whether an access pattern associated with a respective threat event record object 410a satisfies (e.g., exceeds) the access threshold parameter.

In various embodiments, the at least one threat detection policy 412a is a first threat detection policy of a plurality of threat detection policies 412a-n associated with the threat detection model 118. Additionally, the plurality of threat detection policies 412a-n may be associated with a plurality of clients, where the plurality of clients is associated with a plurality of collaborative software application frameworks 102a-n, where each threat detection policy of the plurality of threat detection policies 412a-n is associated with one or more respective access threshold parameters. In some embodiments, the one or more respective access threshold parameters associated with the at least one threat detection policy 412a are configured by a first client of the plurality of clients via the interactive threat detection dashboard 414.

At operation 1008, the threat detection computing device 120 includes means such as the communications circuitry 208, input/output circuitry 206, memory 204, and/or processor 202, or any combination thereof that, in response to determining that the access pattern associated with the at least one threat event record object 410a satisfies the at least one access threshold parameter, generates, based on the at least one threat detection policy 412a employed by the threat detection model 118, at least one access threat alert associated with the collaborative software application framework 102a.

In various embodiments, a respective access threat alert 126a may be configured to comprise various data, information, text, and/or other media used to describe a respective access threat and/or incident associated with a collaborative software application framework 102a. As such, access threat alerts 126a-n are configured to describe whether a collaborative software application framework 102a (e.g., a collaborative work platform 107, service-oriented platform 108, and/or monolithic platform 110 associated with the collaborative software application framework 102a) is currently being accessed and/or has been accessed in the past in a suspicious manner. For example, in various contexts, an access threat alert 126a may indicate that one or more portions of content data associated with a collaborative software application framework 102a (e.g., a collaborative work platform 107, service-oriented platform 108, and/or monolithic platform 110 associated with the collaborative software application framework 102a) is currently being crawled and/or has potentially been crawled in the past (e.g., by an automated bot, malware, spyware, virus, bad actor, and/or the like). A respective access threat alert 126a may also describe an impact to the operating functionality of the collaborative software application framework 102a. Such operating functionality may include indicators regarding the performance of the collaborative software application framework 102a (e.g., whether the various components of the collaborative software application framework 102a are running at peak speed or slower than peak speed, if certain functions or capabilities are not running at peak performance or are not running at all, etc.).

In various embodiments, access threat alerts 126a-n are associated with one or more alert attributes including at least one of an alert severity, an alert identifier, an access threat alert type, an alert description, an alert data source, an alert timestamp, an alert responder profile, an alert mitigation status, or an alert mitigation ticket. Access threat alerts 126a-n and/or one or more portions of data related to access threat alerts 126a-n may be generated and/or received by the threat detection management platform 104 (e.g., via the threat detection model 118) and stored in a data lake 404 associated with the threat detection data service 112. In various contexts, access threat alerts 126a-n may be used by the threat detection management platform 104 to generate and/or cause the transmission of one or more notifications (e.g., via an interactive threat detection dashboard 414).

At operation 1010, the threat detection computing device 120 includes means such as the communications circuitry 208, input/output circuitry 206, memory 204, and/or processor 202, or any combination thereof, that causes display of the at least one access threat alert via an interactive threat detection dashboard 414 rendered on a client computing device 106a associated with the collaborative software application framework 102a. For example, the threat detection management platform 104 may be configured to generate one or more interactive graphs, tables, notifications, and/or the like based on one or more portions of data associated with the access threat alerts 126a-n. In various contexts, the one or more interactive graphs, tables, alert notifications, and/or the like may be displayed via an interactive threat detection dashboard 414 rendered by one or more client computing devices 106a-n associated with the one or more collaborative software application frameworks 102a-n. Furthermore, the threat detection management platform 104 is configured to facilitate the routing and/or transmission of said alert notifications to one or more appropriate alert responder profiles (e.g., alert responder profiles associated with a respective alert response team) associated with the collaborative software application framework 102a.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus.

Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data.

Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. An apparatus for performing access threat detection for a collaborative software application framework, the apparatus comprising at least one processor and at least one memory including program code, the at least one memory and the program code configured to, with the at least one processor, cause the apparatus to at least:
access event data associated with the collaborative software application framework;
identify at least one threat event record object based on the event data, wherein the at least one threat event record object describes an access pattern associated with an entity, and wherein the access pattern is associated with an access to the collaborative software application framework by the entity;
determine, via at least one threat detection policy employed by a threat detection model, that the access pattern associated with the at least one threat event record object satisfies at least one access threshold parameter; and
in response to determining that the access pattern associated with the at least one threat event record object satisfies the at least one access threshold parameter:
generate, based on the at least one threat detection policy employed by the threat detection model, at least one access threat alert associated with the collaborative software application framework; and
cause display of the at least one access threat alert via an interactive threat detection dashboard rendered on a client computing device associated with the collaborative software application framework.

2. The apparatus of claim 1, wherein the at least one threat detection policy is a first threat detection policy of a plurality of threat detection policies associated with the threat detection model,
wherein the plurality of threat detection policies is associated with a plurality of clients, wherein the plurality of clients is associated with a plurality of collaborative software application frameworks, and
wherein each threat detection policy of the plurality of threat detection policies is associated with one or more respective access threshold parameters.

3. The apparatus of claim 2, wherein the one or more respective access threshold parameters associated with the first threat detection policy are configured by a first client of the plurality of clients via the interactive threat detection dashboard.

4. The apparatus of claim 2, wherein the at least one threat event record object is a first threat event record object of a batch of threat event record objects,
wherein the batch of threat event record objects is associated with the plurality of collaborative software application frameworks, and
wherein the threat detection model is applied to the batch of threat event record objects.

5. The apparatus of claim 1, wherein the program code is configured to, with the at least one processor, further cause the apparatus to:
generate, via a threat detection data service and based at least in part on at least one access threat detection job initiated by a threat detection job service, one or more dynamic table objects, wherein the one or more dynamic table objects generated based at least in part on metadata associated with the event data; and
generate, via the threat detection data service and based at least in part on one or more database commands initiated by the threat detection job service, the at least one threat event record object based on the event data associated with the one or more dynamic table objects, wherein the one or more database commands are initiated based at least in part on the at least one access threat detection job.

6. The apparatus of claim 5, wherein the threat detection job service is configured to initiate the at least one access threat detection job based on a predefined periodicity of time.

7. The apparatus of claim 1, wherein the at least one threat detection policy employed by the threat detection model is generated based at least in part on at least one portion of client input data received via the interactive threat detection dashboard.

8. The apparatus of claim 1, wherein the at least one access threshold parameter is a first access threshold parameter of a plurality of access threshold parameters,
wherein the plurality of access threshold parameters comprises at least one of a view count, view duration, modification count, modification amount, export count, export amount, import count, or import amount associated with at least one portion of content data associated with the collaborative software application framework; and
wherein each access threshold parameter of the plurality of access threshold parameters is associated with a predetermined time interval.

9. The apparatus of claim 1, wherein the at least one access threat alert is associated with at least one of an alert severity, an alert identifier, an access threat alert type, an alert description, an alert data source, an alert timestamp, an alert responder profile, an alert mitigation status, or an alert mitigation ticket.

10. The apparatus of claim 1, wherein the at least one access threat alert is associated with a respective access threat alert type of a plurality of access threat alert types, and
wherein the plurality of access threat alert types comprise at least one of a collaborative document alert type, an issue tracking alert type, a suspicious search alert type, an administrative account alert type, or a code repository alert type.

11. The apparatus of claim 10, wherein the collaborative document alert type is associated with at least one of an unusual page activity alert associated with a respective collaborative document, a mass page export alert associated with one or more respective collaborative documents, a restricted document access alert, an unauthorized user access alert, or an alert associated with a high volume of collaborative document content being made public.

12. The apparatus of claim 10, wherein the issue tracking alert type is associated with at least one of a mass issue tracking object export alert or unusual issue activity associated with one or more issue tracking objects.

13. The apparatus of claim 10, wherein the administrative account alert type is associated with at least one of an administrative account change alert, an external access granted alert, a security assertion markup language (SAML) alert, an administrative account application programming interface (API) token change alert, or alert associated with a connection of an administrative account to an external third-party service.

14. The apparatus of claim 10, wherein the code repository alert type is associated with at least one of a mass code repository clone alert, a mass code repository export alert, or a mass code repository commit alert.

15. The apparatus of claim 1, wherein the at least one access threat alert is associated with a threat detection payload, wherein the threat detection payload is associated with at least one portion of content data of the collaborative software application framework, and wherein the at least one portion of content data corresponds to an access threat alert type associated with the at least one access threat alert.

16. A computer program product for performing threat detection for a collaborative software application framework, the computer program product comprising at least one non-transitory computer-readable storage medium having computer-readable program code portions stored therein, the computer-readable program code portions configured to:
access event data associated with the collaborative software application framework;
identify at least one threat event record object based on the event data, wherein the at least one threat event record object describes an access pattern associated with an entity, and wherein the access pattern is associated with an access to the collaborative software application framework by the entity;
determine, via at least one threat detection policy employed by a threat detection model, that the access pattern associated with the at least one threat event record object satisfies at least one access threshold parameter; and
in response to determining that the access pattern associated with the at least one threat event record object satisfies the at least one access threshold parameter:
generate, based on the at least one threat detection policy employed by the threat detection model, at least one access threat alert associated with the collaborative software application framework; and
cause display of the at least one access threat alert via an interactive threat detection dashboard rendered on a client computing device associated with the collaborative software application framework.

17. A computer-implemented method for performing threat detection for a collaborative software application framework, the computer-implemented method comprising:
accessing event data associated with the collaborative software application framework;
identifying at least one threat event record object based on the event data, wherein the at least one threat event record object describes an access pattern associated with an entity, and wherein the access pattern is associated with an access to the collaborative software application framework by the entity;
determine, via at least one threat detection policy employed by a threat detection model, that the access pattern associated with the at least one threat event record object satisfies at least one access threshold parameter; and
in response to determining that the access pattern associated with the at least one threat event record object satisfies the at least one access threshold parameter:
generate, based on the at least one threat detection policy employed by the threat detection model, at least one access threat alert associated with the collaborative software application framework; and
cause display of the at least one access threat alert via an interactive threat detection dashboard rendered on a client computing device associated with the collaborative software application framework.

18. The computer-implemented method of claim 17, wherein the at least one threat detection policy is a first threat detection policy of a plurality of threat detection policies associated with the threat detection model,
wherein the plurality of threat detection policies is associated with a plurality of clients, wherein the plurality of clients is associated with a plurality of collaborative software application frameworks, and
wherein each threat detection policy of the plurality of threat detection policies is associated with one or more respective access threshold parameters.

19. The computer-implemented method of claim 18, wherein the one or more respective access threshold parameters associated with the first threat detection policy are configured by a first client of the plurality of clients via the interactive threat detection dashboard.

20. The computer-implemented method of claim 18, wherein the at least one threat event record object is a first threat event record object of a batch of threat event record objects,
wherein the batch of threat event record objects is associated with the plurality of collaborative software application frameworks, and
wherein the threat detection model is applied to the batch of threat event record objects.
